(19) United States
(12) Patent Application Publication
(10) Pub. No.: US 2004/0129493 A1
(43) Pub. Date: Jul. 8, 2004

(54) MOLDED LIGHTWEIGHT FOAM ACOUSTICAL BARRIER AND METHOD OF ATTENUATING NOISE

(75) Inventor: Michael T. Campbell, Grand Rapids, MI (US)

Correspondence Address: MCGARRY BAIR PC, 171 MONROE AVENUE, N.W., SUITE 600, GRAND RAPIDS, MI, 49503, US

(73) Assignee: CASCADE ENGINEERING, INC., Grand Rapids, MI (US)

(21) Appl. No.: 10/707,727

(22) Filed: Jan. 7, 2004

Related U.S. Application Data
(60) Provisional application No. 60/319,840, filed on Jan. 7, 2003.

(51) Int. Cl. F01N 1/00; B64F 1/26; G10K 11/00; E04H 17/00; E04B 1/82

(52) U.S. Cl. 181/204; 181/210; 181/286

(57) ABSTRACT

An acoustical barrier comprises a layer of molded firm-flexible foam that is generally configured to match the acoustical requirements in an environment and mounted against a sound-transmitting substrate and can have one or more areas of patterned recesses along a substrate-facing side or varying thickness tailored to the intensity of sound transmitted through the sound-transmitting substrate with or without a thin, impervious barrier layer overlying the foam layer.

### CROSS REFERENCE TO RELATED APPLICATIONS

This application claims the benefit of U.S. provisional application Serial No. 60/319,840, filed Jan. 7, 2003, which is incorporated herein in its entirety.

### BACKGROUND OF INVENTION

1. Field of the Invention

This invention relates to acoustical barriers for motor vehicles, and more particularly to acoustical barriers that reduce the sound entering the passenger compartment of the vehicle. In one of its aspects, the invention relates to a lightweight acoustical barrier that satisfies current motor vehicle sound attenuation and transmission standards. In another aspect, the invention relates to a method for attenuating the noise between and engine compartment and a cabin of a motor vehicle.

2. Description of the Related Art

Acoustical barriers are commonly used in contemporary motor vehicles to reduce engine and road noise entering the passenger compartment. Most vehicles have walls forming the passenger compartment made of sheet metal, such as a firewall separating the engine compartment and the passenger compartment, door panels, and floor panels. These metal walls readily transmit sound from the exterior of the vehicle and from the engine compartment into the passenger compartment. Thus, acoustical barriers are frequently incorporated into the vehicle to reduce such sound.

Acoustical barriers can be designed to reduce sound at different frequency ranges. For example, an acoustical barrier that could reduce sound over the range of 100-4000 Hz would improve the acoustical conditions in a vehicle passenger compartment relative to virtually all unwanted sound. Prior art sound barriers have been developed for a frequency range from 200 to 1200 Hz, representing a typical range of frequencies to be reduced.

Prior art acoustical barriers generally comprise a two-part panel comprising a sound absorbing panel of soft, flexible foam such as polyurethane, a fiber panel of PET, or a mix of polymer and natural fibers, bonded to a molded mass layer, such as synthetic rubber, polyvinyl chloride, ethylene vinyl acetate copolymer, modified polypropylene, or other thermoplastic or thermoset polymer filled with a high density filler such as barium sulfate. The mass layer attenuates the transmission of sound, and the flexible foam layer absorbs sound and separates the mass layer from the sheet metal wall. The sound-attenuating panel typically is in contact with the sheet metal wall inside the passenger compartment.

An example of a two part acoustical barrier is disclosed in U.S. Pat. No. 6,024,190 to Ritzema, which is incorporated herein by reference. The Ritzema patent discloses a two-layer acoustic barrier as described above wherein the foam layer has a plurality of cores or air pockets that reduce the contact area of the foam layer with the firewall.

U.S. Pat. No. 5,886,305 to Campbell et al. discloses a dead pedal integrated into a dash mat assembly comprising a two-layer acoustic barrier having a mass layer made of a filled elastomeric moldable polymer, such as an elastomeric polypropylene, and a foam absorber layer interposed between the mass layer and the firewall.

British Patent Application GB 2216081A to Zenzo Fujita, et al discloses an acoustic mat in contact with a sound-transmitting wall, such as a firewall, comprising a mass layer made of press-molded PVC resin, rubber material, or other plastic material, which is maintained a selected distance from the firewall by a plurality of spacer ribs. An absorption layer comprising felt, urethane foam, glass wool, or the like, can be interposed between the mass layer and the firewall.

Japanese Patent JP 2000230431 to Oshima Hideki, et al. discloses a soundproofing cover for a sound source, such as a vehicle engine, comprising a soft foamed polymer material with a closed cell percentage of 20% or more. U.S. Pat. No. 6,631,937 to Miyakawa et al. discloses a soundproofing cover comprising a polymer foamed material, such as a urethane foam or a rubber foam, having a porosity of from 8 to 10%, wherein the cover comprises mounting straps molded therein for attaching the cover to the sound source.

Soft, flexible foam has desirable sound-absorption properties, and can structurally decouple a barrier layer from the underlying substrate. However, it has a low transmission loss on its own. Thus, a mass/barrier layer is typically utilized in a two-layer laminate with the absorbing layer to provide the necessary sound transmission loss properties as well as to provide some measure of integrity to the flexible foam. The resulting two-layer laminate is very pliable and is only partially self-supporting.

The two layer laminate described above is manufactured in at least three steps. The mass layer is injection molded or thermoformed. The absorbing layer is formed by cutting a uniform thickness sheet to meet the acoustic absorption requirements, or molding the layer to a specified shape. The absorbing layer thus formed is then adhesively or mechanically attached to the mass layer, or alternatively the mass layer is inserted into a mold for fabricating the absorbing layer, and the barrier and absorbing layers are then trimmed together.

Two-layer acoustical barriers are typically relatively heavy due, in part, to the use of the filled mass layer. In addition, the laminates are relatively pliable and somewhat difficult to handle. Lighter materials such as closed cell polyolefin foam have been used for the mass layer to reduce the weight of the barrier. However, the sound-blocking properties of laminates made from such materials are significantly reduced.

Molded non-woven fabrics and other fibrous battings that are impregnated with a thermosetting or thermoplastic resin have also been proposed. These sound insulating layers have good absorption properties but, without an impermeable barrier layer, achieve a reduced sound transmission loss. See, for example, Japanese Patent No. 600090741, published May 21, 1985, and Japanese Patent No. 57041229, published Mar. 8, 1982.

### SUMMARY OF INVENTION

According to the invention, an acoustical barrier comprises a sheet of lightweight firm-flexible foam formed into a shape that is adapted to be mounted to a sound transmitting substrate and has the acoustic properties by itself that meets both requisite sound absorption and sound transmission attenuation standards. Typically, the sheet is molded into a complex shape and has sufficient stiffness that it retains its shape during handling, shipment and installation.

The acoustical barrier typically has an obverse side and a reverse side the latter of which is adapted to be placed in contact with the sound transmitting substrate. In one embodiment, pattern recesses are formed in at least a portion of the reverse side and the pattern recesses are adapted to attenuate the transmission of sound from the sound transmitting substrate against which the reverse side of the acoustical barrier is adapted to be placed. In one embodiment, the spacing and pattern of the recesses define a regular array. In another embodiment, the spacing and pattern of the recesses define an irregular array. Typically, the spacing and pattern of the recesses define a regular array of spaced support columns that are adapted to contact the sound transmitting substrate when the acoustical barrier is installed on the sound transmitting substrate.

In another embodiment, the thickness of the sheet varies to exhibit different acoustical properties at different portions of the sheet.

The stiffness of the foam is important to maintain the structural integrity of the foam sheet during handling, shipment, and installation and to improve the transmission loss characteristics. Generally, the density of the foam sheet is in the range of about 2 to 9 lbs per cubic foot, preferably about 3.5 lbs per cubic foot. Further, the foam has a stiffness of at least 30 and generally between 30 and 300 pounds-force at a 25% indentation force deflection (IFD) using a 20″×20″×2″ test sample pursuant to ASTM D3574-01 specifications. The porosity of the foam can vary over a wide range. Typically, the foam has an open porosity with pore sizes in the range of 20 to 120 pores per inch, and preferably 40 to 75 pores per inch.

In another embodiment of the invention, a dash mat adapted to be installed against a firewall in a motor vehicle and within the passenger compartment of the vehicle comprises a layer of molded lightweight firm-flexible foam that has a shape that generally conforms to the firewall of the vehicle and has acoustical transmission loss properties that are at least as great as curve 72 illustrated on FIG. 7 herein.

In a preferred embodiment, the acoustical transmission loss properties are as great as curve 74 when some pattern of recesses is used and at least as great as curve 72 when no recesses are used.

In a preferred embodiment, the foam layer is designed for selected areas that are configured to adjust the acoustical properties of the foam layer to match predetermined sound transmission requirements at selected corresponding areas of the firewall. These selected areas can be recessed along a reverse side of the foam layer that attenuate transmission sounds through the foam layer. In addition, or alternatively, the selected areas can comprise an enlarged wall thickness, thus increasing lower frequency sound absorption. In a particular embodiment, an enlarged wall thickness at least partially surrounds an opening in the foam layer. In another embodiment, selected regions of the foam will have intimate contact with the firewall panel, thus improving lower frequency damping. The foam layer has sufficient stiffness to retain its shape during packaging, shipment and installation.

Further according to the invention, a vehicle having a firewall separating an engine compartment from a passenger compartment has a dash mat as described above positioned within the passenger compartment against the firewall.

Further according to the invention, a method for providing sound transmission loss through a firewall between a motor compartment and a cabin of a vehicle comprises the steps of:

mapping the sound intensity through the firewall between the engine compartment and the cabin as a function of a set of coordinates of a cabin surface of the firewall that faces the cabin;

selecting a firm flexible foam that has both sound transmission and sound absorbing properties and that has structural integrity for handling, shipping and installation;

designing a layer of the selected flexible-firm foam in a shape that generally conforms to the cabin surface of the firewall and that has selected areas that are designed with configurations that have different acoustical properties that correspond to the mapped sound transmission properties as a function of the set of coordinates; and

forming, preferably by molding, the designed layer of firm flexible foam into a shape to generally conform to the firewall cabin surface.

In a preferred embodiment of the invention, the method of attenuating sound transmission through the firewall further comprises a step of installing the formed layer onto the firewall cabin surface of the vehicle.

In one embodiment, the designing step includes designing at least one selected area with recesses along a reverse side of the foam layer and that attenuates transmission sounds through the foam layer. The spacing and pattern of the recesses can define a regular or an irregular array. In another embodiment, the designing step can include the step of designing at least one selected area with an enlarged wall thickness to increase sound absorption through the foam layer.

In another embodiment, one or more openings are designed into the foam layer and an enlarged wall thickness is designed to at least partially surround the opening in the foam layer. The designing step further comprises the step of designing the foam material, the thickness and shape of the foam layer so that the foam layer has sufficient stiffness to retain its shape during packaging, shipment and installation.

The designing step includes, in a preferred embodiment, the step of designing thickness variations in the foam layer to exhibit different acoustical properties at different portions of the foam layer corresponding to selected coordinates of the firewall cabinet. The foam layer of the method according to the invention has the same characteristics as defined above with respect to the dash mat.

The acoustical panel according to the invention can have a generally constant thickness acoustic barrier with a plurality of regularly-spaced, regularly-sized cores formed in one side of the panel. Alternately or in addition, the acoustical panel can have a generally constant thickness acoustic barrier having a plurality of irregularly-spaced, irregularly-sized cores formed on one side of the panel. Still further, the acoustical panel can have a variable thickness, either incorporating or omitting cores formed on the reverse side of the panel.

The invention provides a lightweight foam acoustical barrier embodied as a single layer foam, with or without a light barrier layer, dash mat for reducing the sound entering the passenger compartment of a motor vehicle. Preselected sound-attenuating specifications are satisfied in a dash mat meeting weight and stiffness requirements. Further, the molded acoustical panels can be formed in large components, such as dash mats, that have the structural integrity for shape retention during handling, shipping and installation in an automobile. An acoustical panel having both sound absorption and sound transmission attenuation properties according to the invention can be manufactured in a single conventional molding step, or with an additional laminating step, if desired.

### BRIEF DESCRIPTION OF DRAWINGS

In the drawings:

FIG. 1 is a perspective view of a portion of the interior of the passenger compartment of a motor vehicle illustrating a first embodiment of an acoustical barrier comprising a molded lightweight foam dash mat according to the invention.

FIG. 2 is a close-up perspective view of an obverse side of the dash mat of FIG. 1.

FIG. 3 is a close-up view of a portion of a reverse side of the dash mat of FIG. 2.

FIG. 4 is a first sectional view of the dash mat taken along view line 4-4 of FIG. 2.

FIG. 5 is a second sectional view of the dash mat taken along view line 5-5 of FIG. 2.

FIG. 6 is a third sectional view of the dash mat taken along view line 6-6 of FIG. 2.

FIG. 6A is a sectional view of an alternate embodiment of the dash mat taken along view line 6-6 of FIG. 2.

FIG. 7 is a graphical representation of the reduction in sound for three different acoustical barriers as a function of frequency.

FIG. 8 is a perspective view of a portion of the interior of the passenger compartment of a motor vehicle illustrating a second embodiment of an acoustical barrier comprising a molded lightweight foam dash mat according to the invention.

FIG. 9 is a close-up perspective view of a first portion of the dash mat of FIG. 8, illustrating variations in thickness of the dash mat to accommodate variations in sound intensity.

FIG. 10 is a close-up perspective view of a second portion of the dash mat of FIG. 8, illustrating variations in thickness of the dash mat to accommodate variations in sound intensity.

FIG. 11 is a sectional view of the dash mat taken along view line 11-11 of FIG. 9.

FIG. 11A is a sectional view of an alternate embodiment of the dash mat taken along view line 11-11 of FIG. 9.

FIG. 12 is a sectional view of the dash mat taken along view line 12-12 of FIG. 10.

FIG. 13 is a perspective view of a lightweight foam plaque test sample illustrating an array of cores having variable dimensions.

FIG. 14 is a first graphical representation of the reduction in sound as a function of frequency for an acoustical barrier according to the invention and a conventional two-layer barrier.

FIG. 15 is a second graphical representation of the reduction in sound as a function of frequency for an acoustical barrier according to the invention and a conventional two-layer barrier.

FIG. 16 is a close-up cutaway view of a third embodiment of an acoustical barrier according to the invention.

FIG. 17 is a first graphical representation of the reduction in sound as a function of frequency for a range of lightweight foam samples.

FIG. 18 is a second graphical representation of the reduction in sound as a function of frequency for a first grouping of the lightweight foam samples illustrated in FIG. 17.

FIG. 19 is a third graphical representation of the reduction in sound as a function of frequency for a second grouping of the lightweight foam samples illustrated in FIG. 17.

FIG. 20 is a fourth graphical representation of the reduction in sound as a function of frequency for a third grouping of the lightweight foam samples illustrated in FIG. 17.

FIG. 21 is a fifth graphical representation of the reduction in sound as a function of frequency for a fourth grouping of the lightweight foam samples illustrated in FIG. 17.

FIG. 22 is a sixth graphical representation of the reduction in sound as a function of frequency for a fifth grouping of the lightweight foam samples illustrated in FIG. 17.

FIG. 23 is a seventh graphical representation of the reduction in sound as a function of frequency for a sixth grouping of the lightweight foam samples illustrated in FIG. 17.

FIG. 24 is an eighth graphical representation of the reduction in sound as a function of frequency for a seventh grouping of the lightweight foam samples illustrated in FIG. 17.

### DETAILED DESCRIPTION

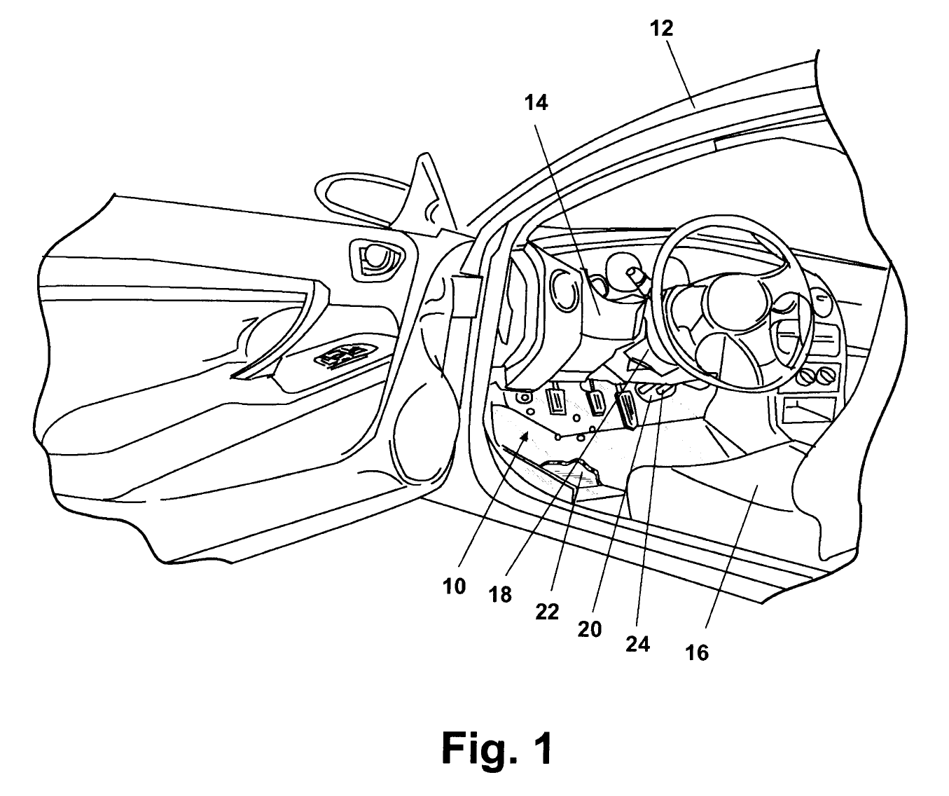

Referring now to the drawings and to FIG. 1 in particular, the invention will be described with respect to a firewall separating a passenger compartment and a vehicle engine compartment. A typical firewall is an irregularly shaped panel comprising cutouts for electrical and mechanical control lines, steering mechanisms, heating and cooling conduits, and the like. It also supports auxiliary devices, such as heating and air-conditioning units, and an instrument panel. The sound penetrating a firewall will be dependent upon such variables as the shape and thickness of the firewall, the number and location of cutouts, and the proximity of sound sources to the firewall. The configuration of an acoustical barrier must take into account such varying factors.

FIG. 1 illustrates a portion of the interior of the passenger compartment of a motor vehicle 12 of a generally conventional configuration comprising an instrument panel 14, a seat 16, a steering column 18, a firewall 20, a floor 22, and climate control lines 24 for providing heating and cooling of the passenger compartment. The firewall 20 separates the engine compartment from the passenger compartment in a generally well-known manner. The floor 22 separates the passenger compartment from the exterior of the vehicle 12, supports the seat 16, and is typically overlain by carpeting or rubber flooring. A molded lightweight foam acoustical barrier 10 according to the invention overlays a substrate 28 comprising the firewall 20 and the floor 22. The acoustical barrier can take forms other than the dash mat 10, for example, an acoustic door panel or an acoustic vehicle roof panel and can be attached to respective supporting substrates for these panels.

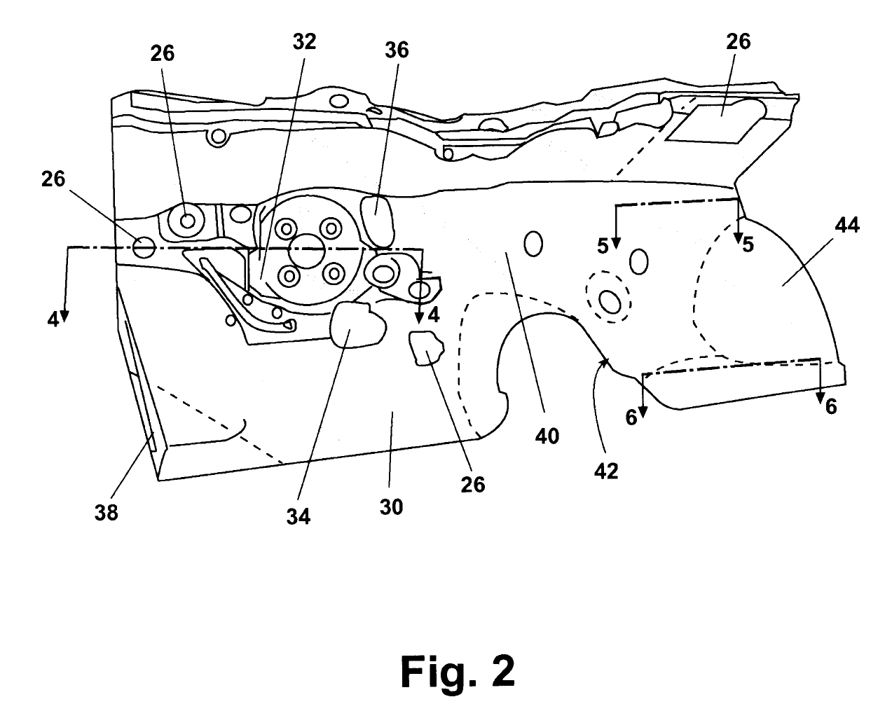

Referring now to FIG. 2, the dash mat 10 is an irregularly-shaped panel comprising a floor section 30 and a firewall section 32, and is provided with a plurality of cutouts 26 for passage of operational components between the engine compartment and the passenger compartment, such as a steering column cutout 34 for passage of the steering column 18 and a climate control line cutout 36 for passage of the climate control lines 24. The cutouts 26 are cooperatively aligned with openings 26 in the substrate 28, such as the firewall 20 or the floor 22, to which the dash mat 10 is attached.

The dash mat 10 is made of a lightweight firm-flexible foam that is sufficiently firm to maintain the integrity of the molded shape for handling, shipping, and installation without undue bending or deformation. Due to the firmness and the low weight of the molded dash mat, it is self supporting without collapse when handled in an ordinary manner. However, the foam is flexible in the sense that it is resilient so that it retains its sound absorption properties similar to softer flexible foam. Thus, the foam has sufficient stiffness to be resilient and to have sufficient sound absorption properties to meet commercial acoustic requirements for a particular application and sufficient rigidity or firmness that it is self supporting and has the requisite sound transmission attenuation properties to meet this aspect of commercial acoustical requirements for the particular application.

Typically, the firmness of the molded foam dash mat 10 is reflected in part in its stiffness, which is greater than 30 pounds-force at a 25% indentation force deflection (IFD) using a 20″×20″×2″ test sample according to ASTM D3574-01 specifications. This IFD is a measure of stiffness or firmness, which is inversely related to flexibility; i.e. an increase in flexibility is reflected in a decrease in the IFD value.

The foam is preferably open cell foam, and can be made from any suitable thermoplastic or thermosetting resin. Preferably, the resin is a thermosetting resin, for example polyurethane. The acoustical properties of the foam can be achieved by selecting the density, stiffness, and porosity of the foam. The density of the foam can vary over a relatively wide range but preferably is in the range of 2 to 9 lb/cu ft. In a preferred embodiment, the foam has a density of about 3.5 lb/cu ft and a stiffness of greater than 30 pounds-force (200 Newtons) at a 25% indentation force deflection (IFD) using a 20″×20″×2″ test sample according to ASTM D3574-01 specifications. The porosity of the foam is approximately 95-96%, with 20 to 120 pores per inch, typically between 40 and 75 pores per inch, and preferably about 60 pores per inch.

As an example, the foam can be a two-component, low-density, firm-flexible polyurethane foam having suitable acoustic properties, comprising a polyol such as Dow Chemical Company DNS 648.01 polyol and an isocyanate such as Dow Chemical Specflex® NS 1540 isocyanate. The proportions by weight of the polyol to the isocyanate range from 1.818 to 1.212, with a preferred proportion being 1.333. At the preferred proportion, the foam exhibits the preferred stiffness for use as a single layer acoustical barrier. Table 1 summarizes the proportions of polyol and isocyanate, and the resulting density and stiffness, for several representative foams.

TABLE 1
Mix Proporation, Density, and Deflection Characteristics
Lightweight Foam

| | | | | | |
|---|---|---|---|---|---|
| Mixture | 80I | 90I | 100I | 110I | 120I |
| Identification | | | | | |
| Wt. | 1.818 | 1.613 | 1.46 | 1.333 | 1.212 |
| Polyol/ | (100/55) | (100/62) | (100/68.5) | (100/75) | (100/82.5) |
| Wt. | | | | | |
| Isocyanate, | | | | | |
| (gm/gm) | | | | | |
| Sectional | N/A | 3.12 | 3.07 | 3.09 | 3.15 |
| Density, | | | | | |
| lb/cu ft | | | | | |
| 25% IFD, | N/A | 49.5 | 69.9 | 91.9 | 113.3 |
| lbf | | | | | |

The dash mat can be formed by an open or closed pour process, with the preferred process being an open pour utilizing a two-piece mold. The components are mixed in a suitable mixing/extrusion machine, and extruded or poured into the lower mold where expansion of the foam takes place. The upper mold is then positioned with the lower mold to shape the upper surface of the dash mat during curing. The molds are preferably maintained at a temperature of 120-150° F. during the extrusion and curing process.

The dash mat according to the invention will have acoustical properties that satisfy commercial requirements for the particular application.

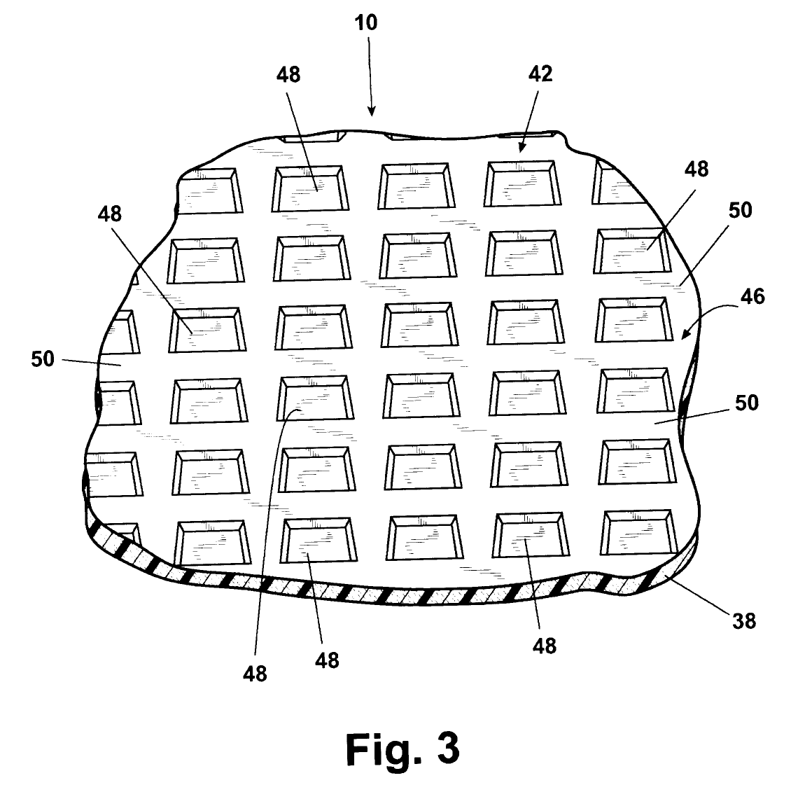

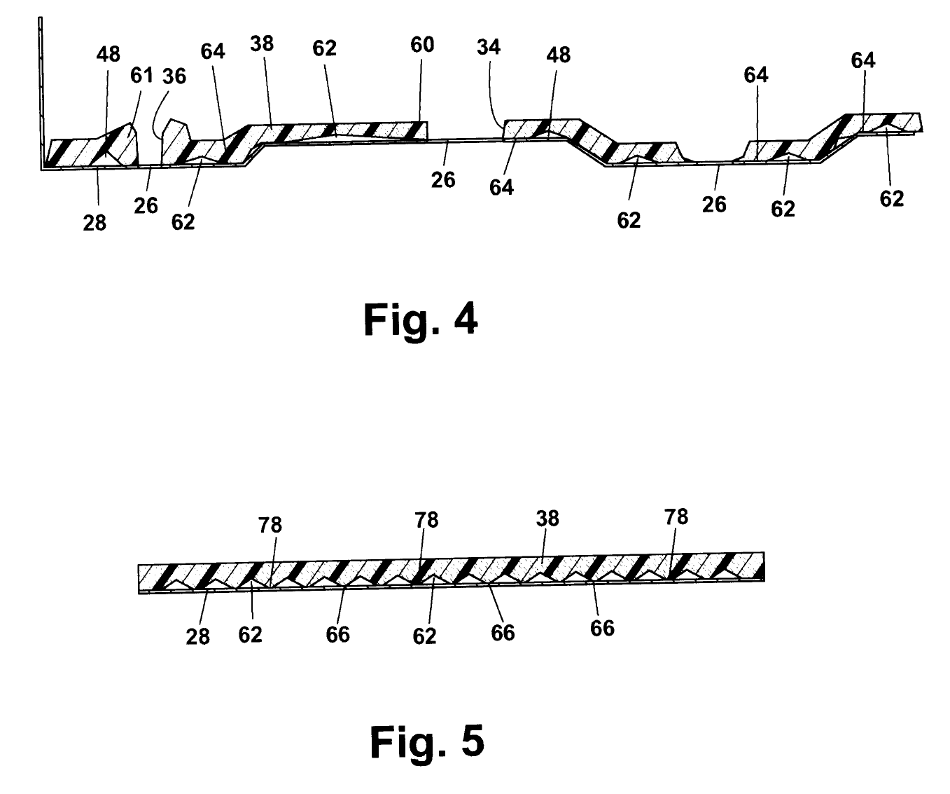

As illustrated in FIG. 2, in a first embodiment the dash mat 10 comprises an obverse side 40 facing the interior of the passenger compartment, and a reverse side 42 in contact with the substrate 28, i.e. the firewall 20 and the floor 22. The obverse side 40 is finished with a smooth surface 44 suitable for attachment of carpeting or rubber flooring. As illustrated in FIG. 3, the reverse side 42 is provided with a cored surface 46. The cored surface 46 comprises a regular array of spaced-apart recesses 48 arranged in rows and columns, cut into the reverse side 42 to extend below the surface 46. This array forms a grid-like contact surface 50. The recesses 48 and the contact surface 50 generally extend across the dash mat 10 in a regular array to terminate at a point short of the perimeter of the dash mat 10. Alternatively, the recesses 48 can form an irregular array or can be irregularly-shaped. As illustrated in FIG. 4, the recesses 48 terminate at areas spaced from the cutouts 34, 36 in order to leave cutout flanges 60, 61 surrounding the cutouts 34, 36. The cutout flange 61 can be thickened to provide additional reinforcement around the cutout as illustrated in FIG. 4.

The recesses 48 provide a plurality of foam cores 62 between the dash mat 10 and the substrate 28 which prevent the transmission of sound through the dash mat 10 at the cores 62. The cores 62 can be of varying spacing, shapes, and depths to accommodate the profile of the substrate 28 and variations in the sound intensity at selected points along the substrate 28. Thus, rather than the regular pattern illustrated in FIG. 3, the reverse side 42 can have recesses that are irregular in shape and depth. The cores 62 are interrupted by contact surfaces 64 which abut the substrate 28 to which it is attached through well-known known fasteners. The thickness of the foam 38 above the cores 62 is dependent upon the sound intensity to be attenuated, the structural integrity desired, and of the space available for occupation by the dash mat 10. Areas of the dash mat 10 corresponding to louder high and middle of frequency sound, such as around cutout components, will be provided with cores 62 selected so as to close sound leak paths through the dash mat 10. Thus, each cored area will generally be separated from other cored areas.

As illustrated in FIG. 5, in areas of louder middle frequency sound, numerous cores 62 are provided to minimize the area of contact of the dash mat 10 with the underlying substrate 28. The contact points 66 can be defined by conical or pyramidal support bodies 78, thereby further minimizing the contact of the dash mat 10 with the substrate 28. The thickness of the foam 38 above the cores 62 will be sufficient to attenuate the higher intensity sound. Areas with fewer cutouts and shape changes can have smaller contact points 66, thereby providing maximum core area at the substrate surface.

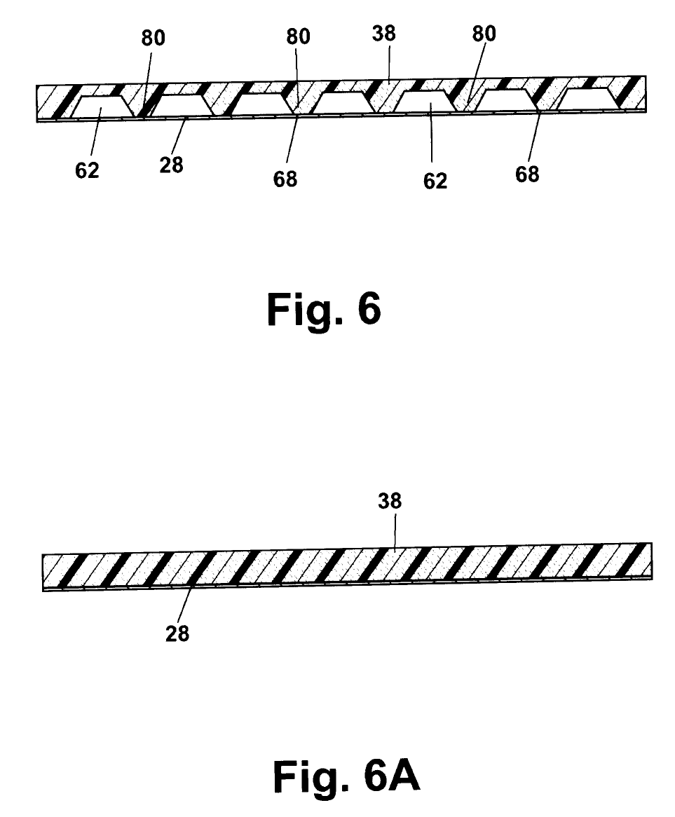

As illustrated in FIG. 6, in areas of greater high frequency sound, such as along the firewall 20, the cores 62 can be structured to provide contact points 68 defined by truncated conical or pyramidal support bodies 80, thereby maximizing the core area at the substrate surface. The thickness of the foam 38 above the cores 62 can be reduced to improve high frequency sound reduction, while providing sufficient structural strength for load support, shape, and fit.

As illustrated in FIG. 6A, in areas of greater low frequency sound, a panel of full thickness foam 38 without cores can be provided to maximize the area of contact of the dash mat 10 with the underlying substrate 28. This relatively high level of contact provides structural damping for low frequency sound within the substrate 28 and avoids a reduction in low frequency transmission loss which would be created by a lightweight barrier layer spaced away from the substrate 28.

Preferably, the foam 38 has a density in the range of 2 to 9 lb/cu ft, and a stiffness of greater than 30 pounds-force at a 25% indentation force deflection (IFD) using a 20″×20″×2″ test sample pursuant to ASTM D3574-01 specifications. The dash mat 10 is preferably fabricated by a well-known open or closed pour process, or a conventional reaction injection molding process, and is adapted to the contours of the substrate 28 to which it is to be attached.

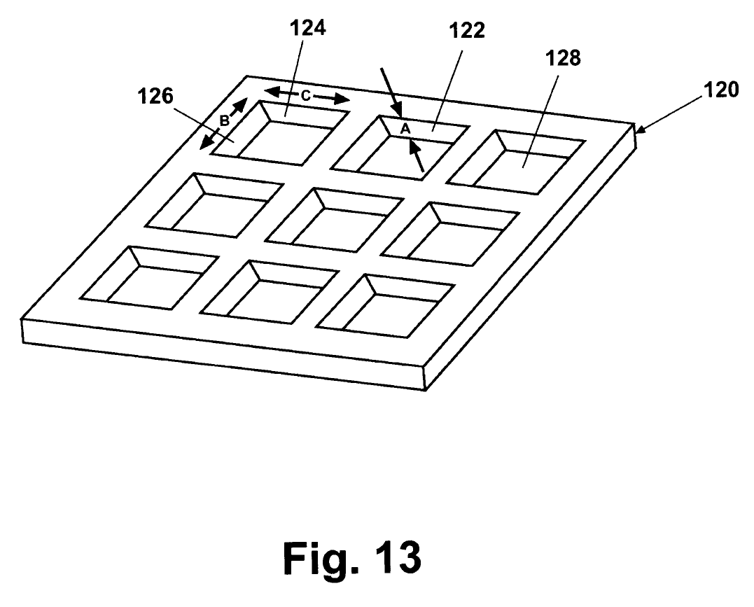

Acoustic testing of the acoustical performance of the lightweight foam was performed on cored plaque samples comprising a range of mixtures of polyol and isocyanate, i.e. a range of indexes. As illustrated in FIG. 13, the plaque samples consisted of thin foam panels 120 having an array of regularly dimensioned and spaced cores 128 attached to a panel of 20-gauge steel. The depth 122, length 124, and width 126 of the cores 128 were varied, as illustrated in Table 2.

TABLE 2
Stiffness, Density, Dimensions, and Transmission Loss
Cored Plaque Samples

| | | Modified | | | | | | Average | |
|---|---|---|---|---|---|---|---|---|---|
| | | Force | | | | | | Transmission | Sample |
| Sample | | Deflection, | Density, | Density, | “A”, | “B”, | “C”, | Loss, | Thickness, |
| No. | Index | lb. | kg/m3 | pcf | in. | in. | in. | dB | in. |
| 1 | 100I | 28 | 123.8 | 7.73 | 0.75 | 2.5 | 2.5 | 42.5 | 1.00 |
| 2 | 110I | 26 | 54.7 | 3.42 | 0.25 | 4 | 4 | 41.8 | 1.00 |
| 2A | 110I | 26 | 54.7 | 3.42 | 0.50 | 4 | 4 | 43.8 | 1.25 |
| 2B | 110I | 26 | 54.7 | 3.42 | 0.75 | 4 | 4 | 45.6 | 1.50 |
| 3 | 80I | 10 | 54.5 | 3.41 | 0.25 | 1.5 | 1.5 | 37.7 | 1.00 |
| 4 | 80I | 10 | 41.5 | 2.59 | 0.75 | 1.5 | 1.5 | 39.6 | 1.00 |
| 5 | 110I | 32 | 55.4 | 3.46 | 0.75 | 1.5 | 1.5 | 41.5 | 1.00 |
| 6 | 80I | 10 | 86 | 5.37 | 0.75 | 2 | 2 | 42 | 1.00 |
| 7 | 100I | 38 | 134.5 | 8.40 | 0.75 | 2 | 2 | 42.6 | 1.00 |

A Modified Force Deflection test was performed on samples of the foam to establish the relative stiffness of the foam. The Modified Force Deflection test results quantify the maximum force required to depress a 1″ thick sample to 0.5″ with a deflector shoe having a 1-inch diameter surface contacting the foam sample. The “modified” force deflections are approximately 3½ times less than for the ASTM D3574-01 25% IFD test.

The plaque tests were performed on plaques that comprised 24″ by 24″ square foam samples. The thickness the foam ranged from 1″ to 1.5″. Each plaque was placed against the substrate of 20-gauge steel to replicate conditions of actual usage. Two speakers were positioned on the substrate side of the plaque, which generated pink noise, a broad frequency spectrum noise having equal intensity levels at every frequency. A microphone was positioned on each side of the plaque, the microphone on the substrate side serving as a source microphone and the microphone on the foam side serving as an anechoic or receiver microphone. With the speakers generating pink noise, the response, i.e. the sound level, of each microphone was measured and averaged. The averaged sound level from the receiver microphone was subtracted from the averaged sound level from the source microphone, this difference being the noise reduction provided by the foam. The data was adjusted pursuant to SAE J-1400, which defines a standard test for normalizing data obtained from different testing environments.

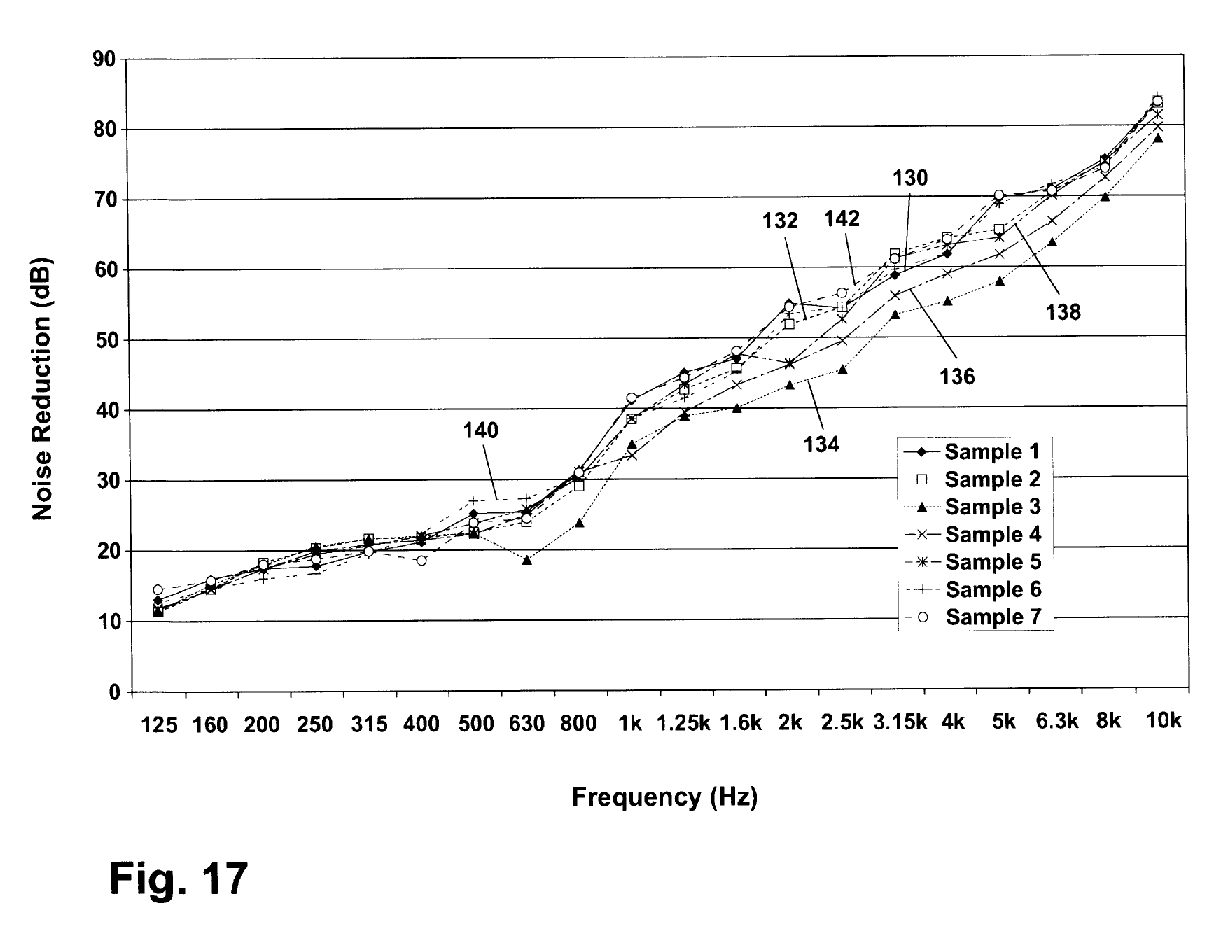

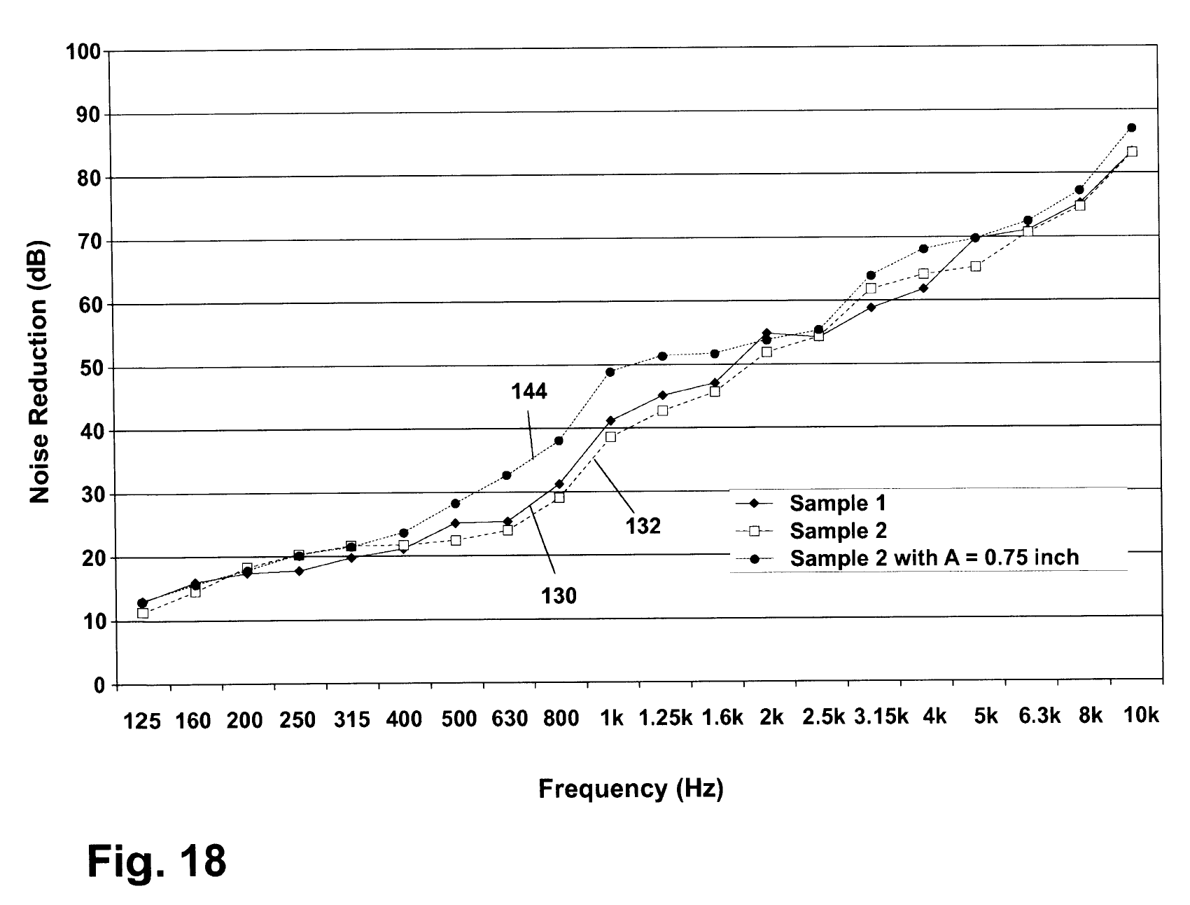

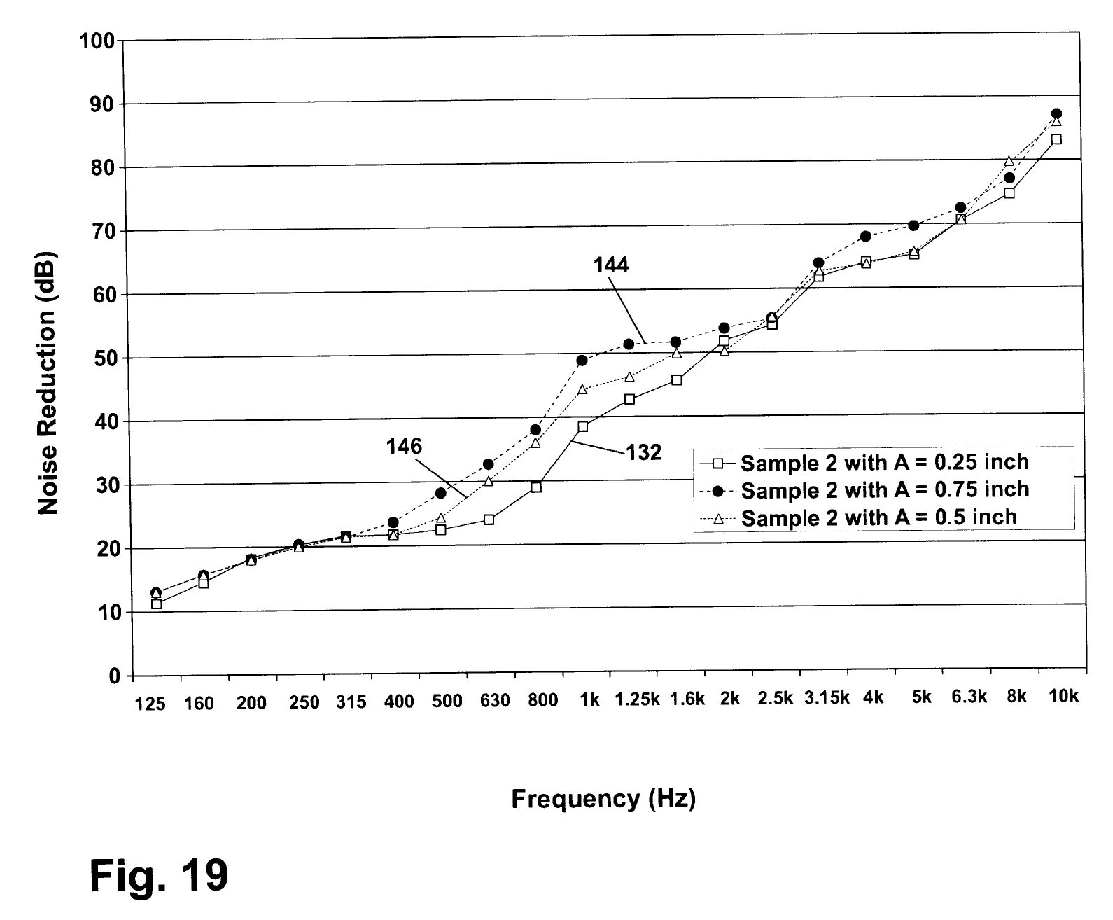

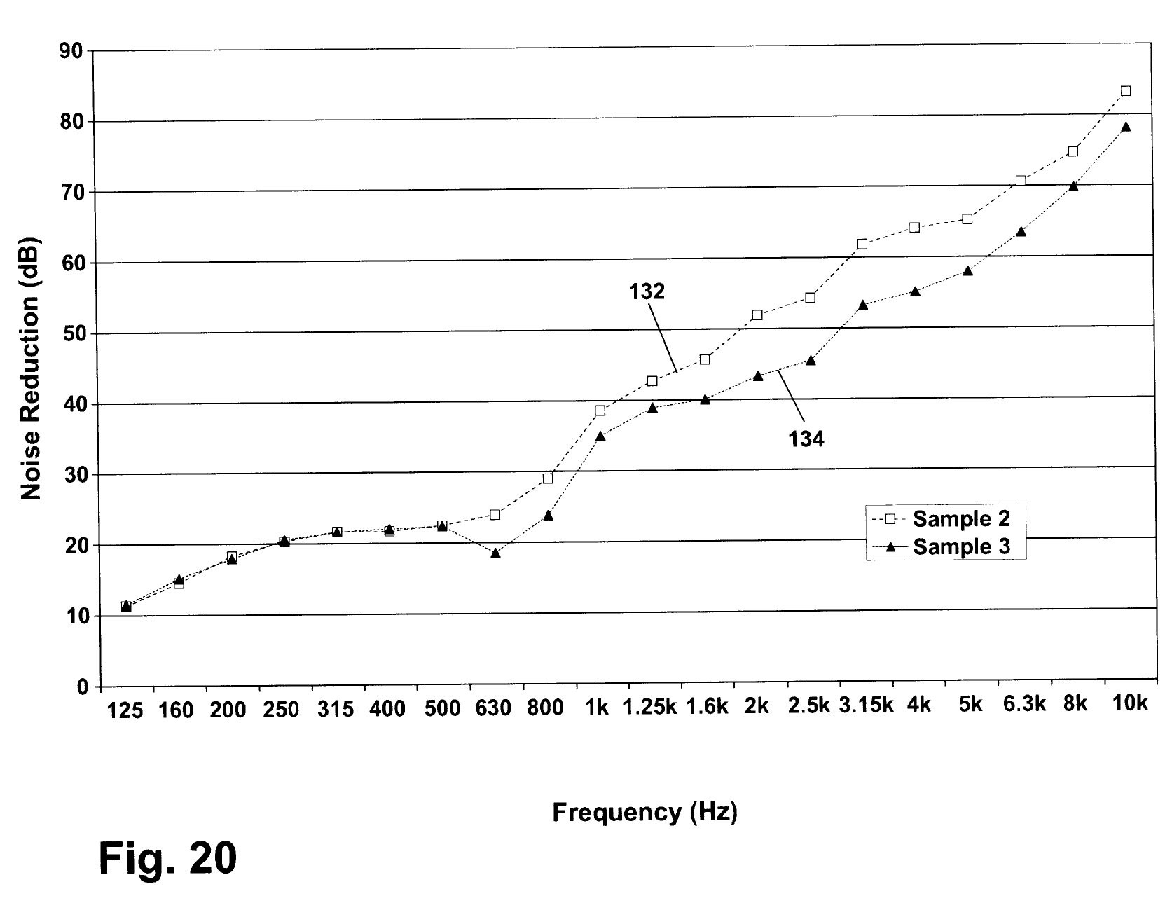

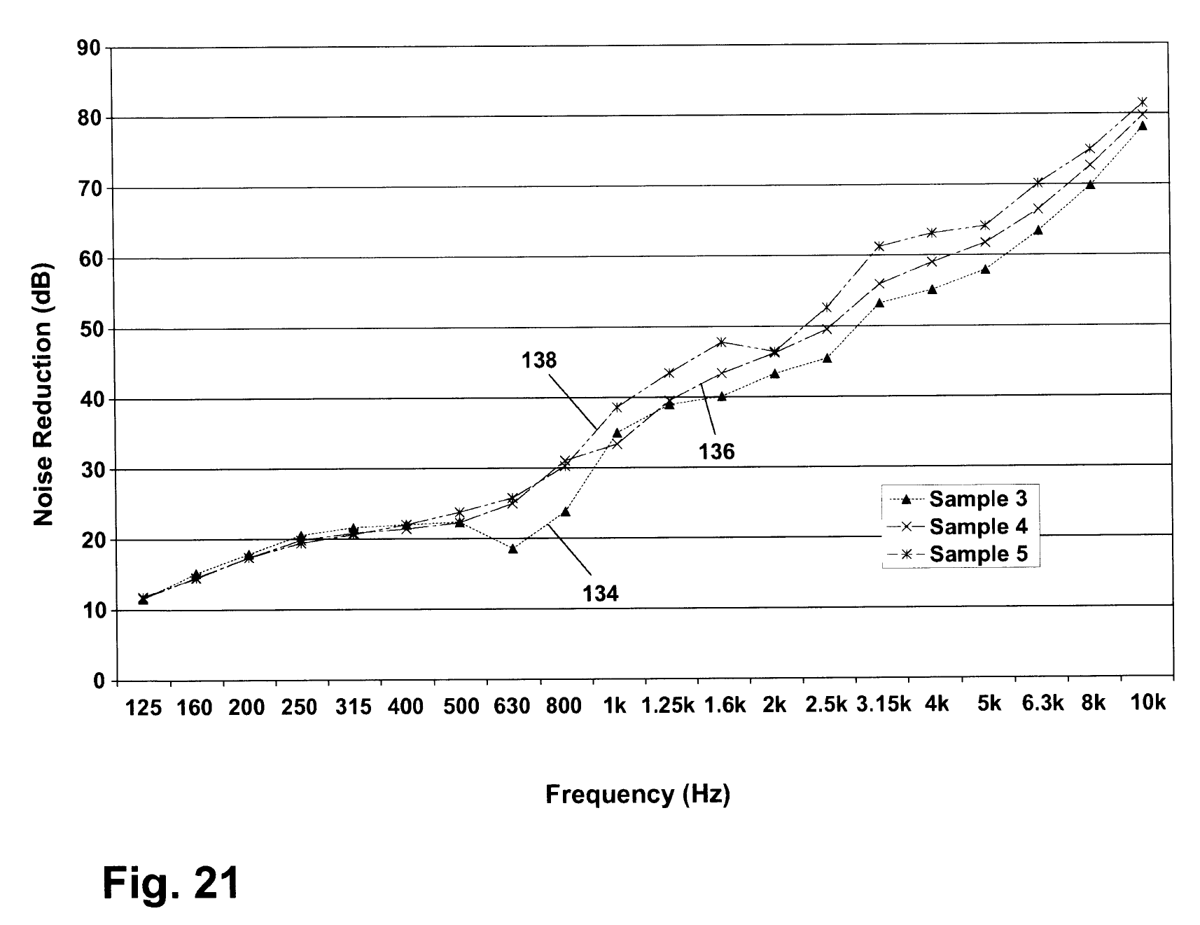

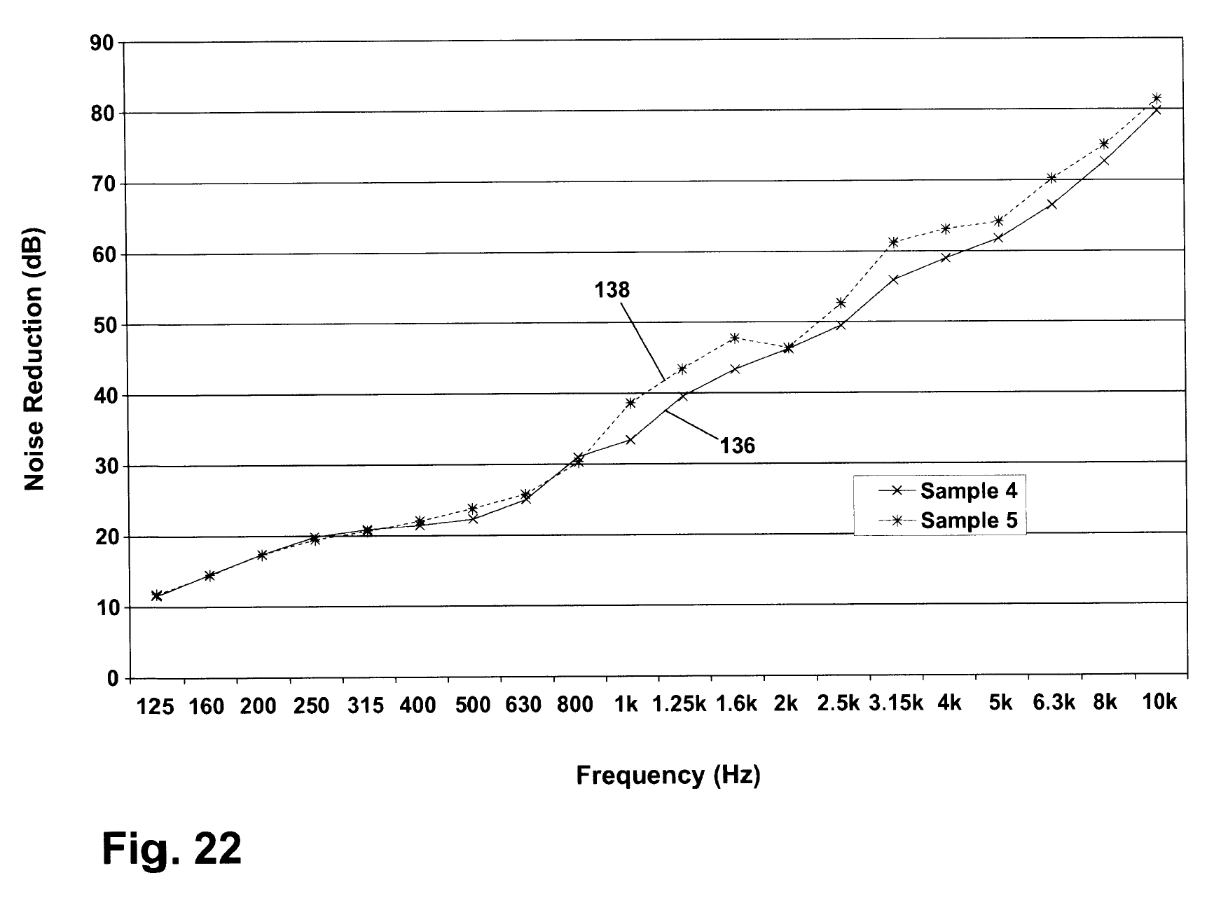

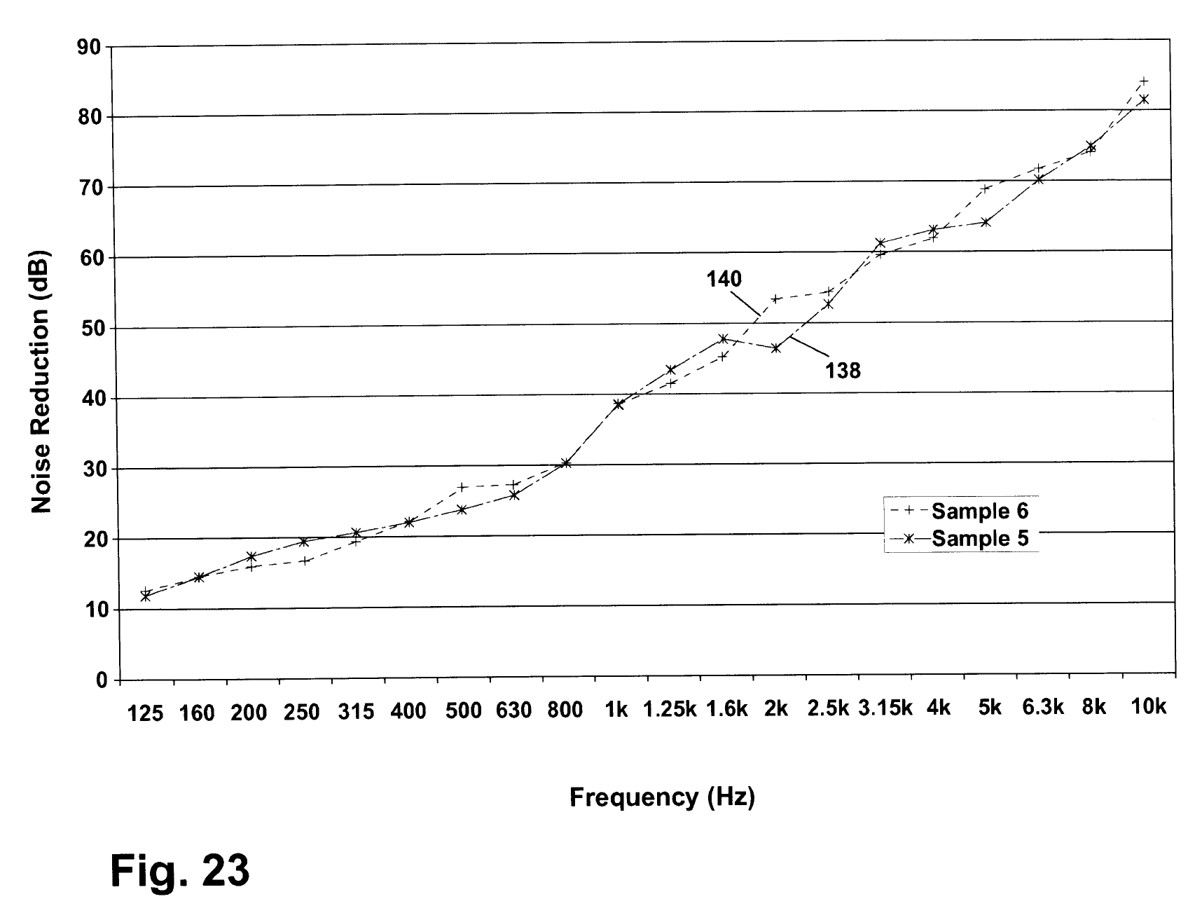

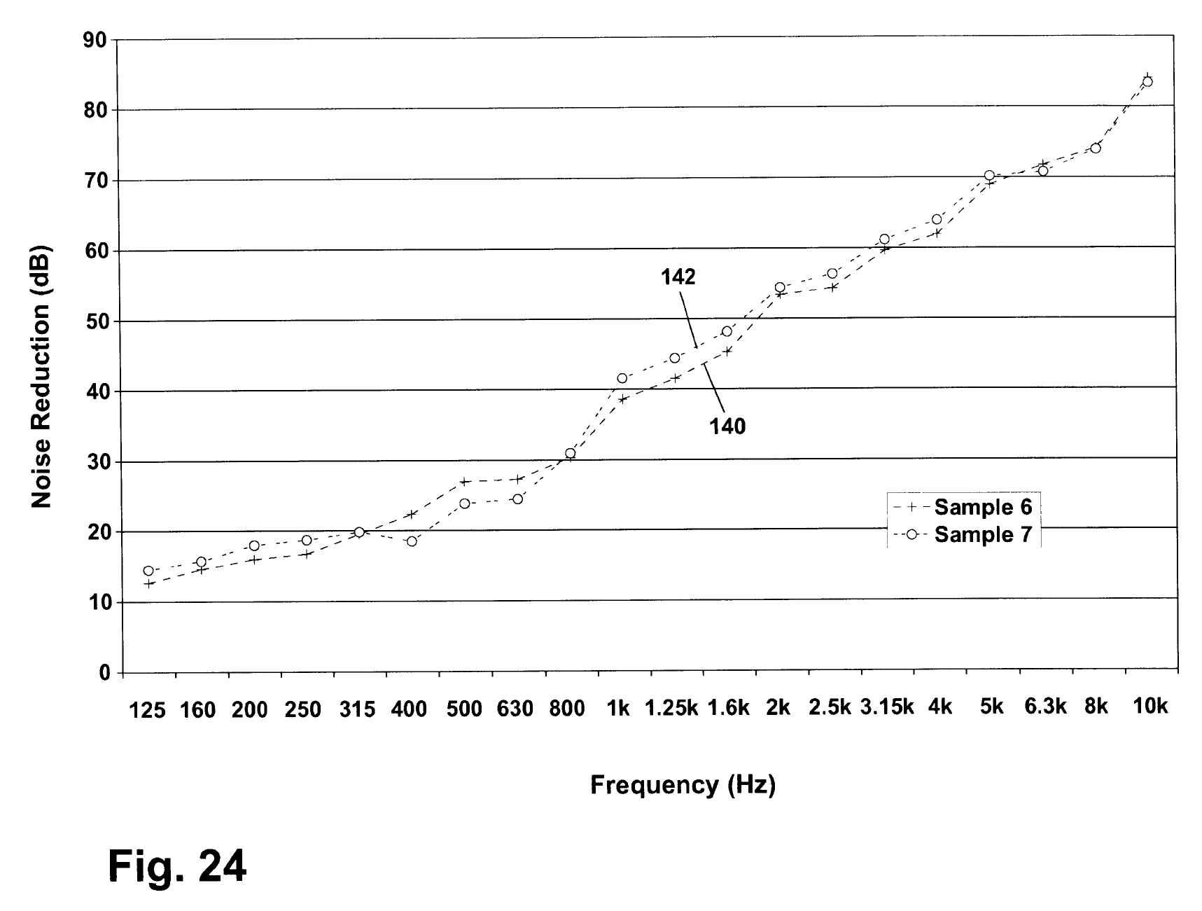

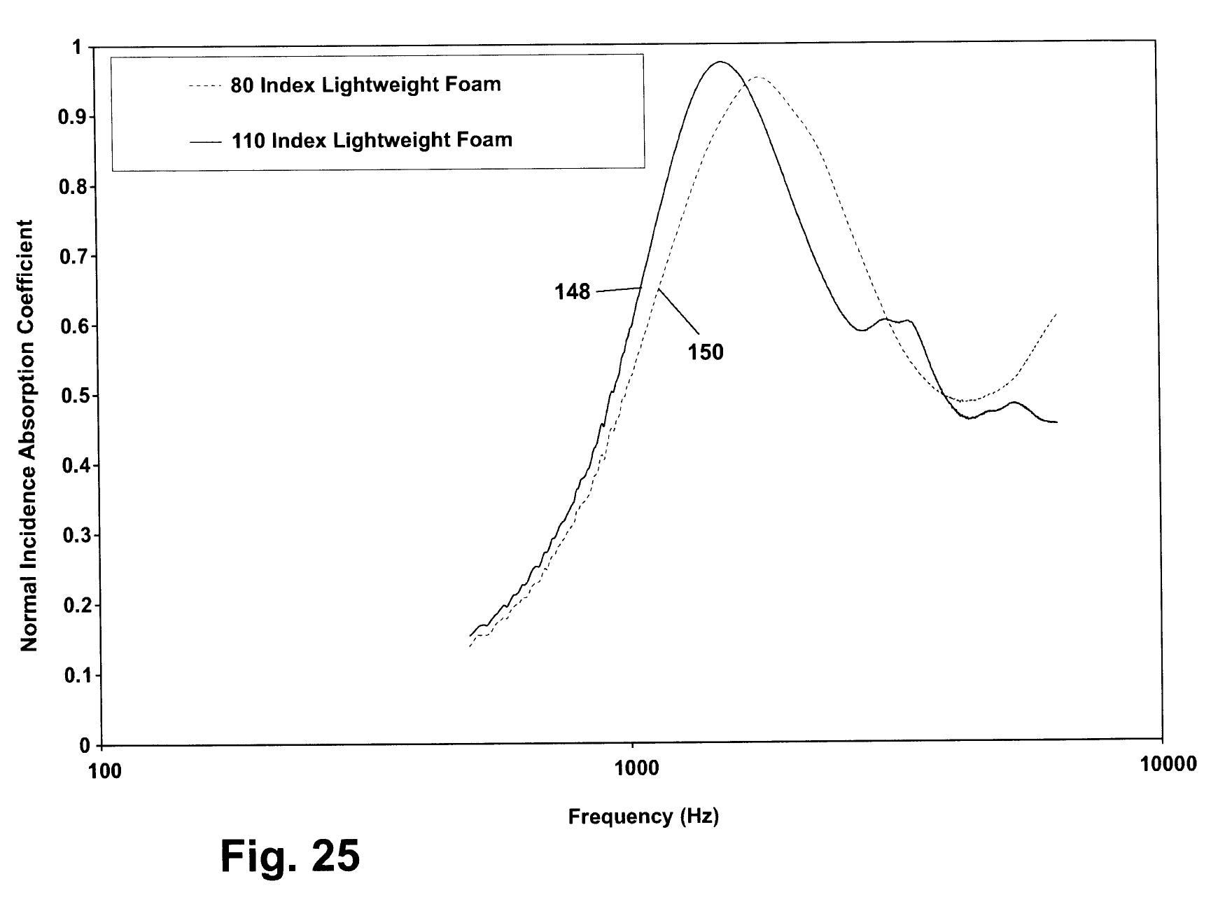

The test results are summarized in Table 2 and FIGS. 17-24, illustrated by curves 130-146. FIGS. 17-24 illustrate the reduction in sound transmission over a range of frequencies of from 125 Hz to 10,000 Hz. In general, the results illustrate that an increase in stiffness results in an increase in sound transmission loss. An increase in core size, particularly depth, also increases sound transmission loss.

Sound reduction due to absorption is also improved with an increase in foam stiffness. FIG. 25 illustrates the results of the measurement of the absorption coefficient using a well-known impedance tube test procedure on an 80 index foam (curve 150) having a stiffness of 10 pounds-force and a 110 index foam (curve 148) having a stiffness of 32 pounds-force. Sound of different frequencies and a selected intensity was directed down the impedance tube toward 14 millimeter thick solid cast foam samples, and the intensity of the reflected sound was measured. The difference between the intensities is a measurement of the sound absorbed. The coefficient is the absorbed sound expressed as a percentage of the intensity of the impedance tube sound intensity. As illustrated in FIG. 25, the higher stiffness foam 148 has a higher coefficient, indicating higher absorption, than the lower stiffness foam 150.

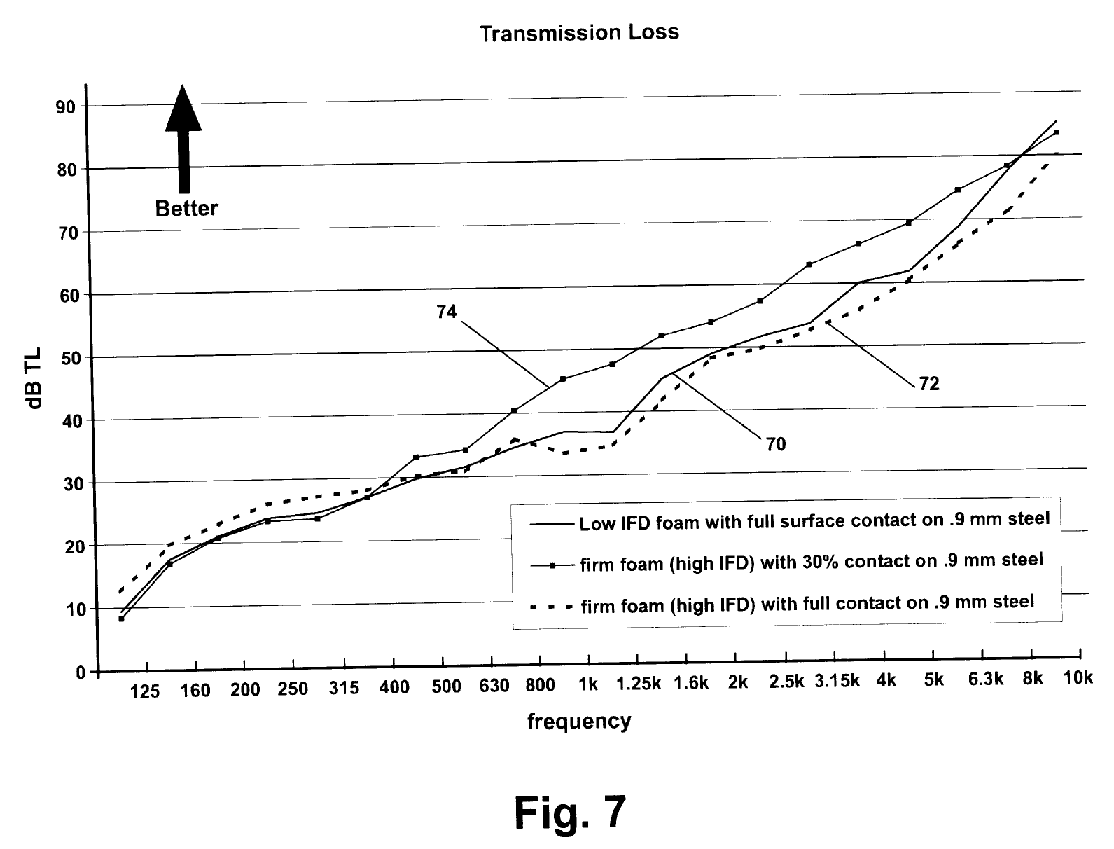

FIG. 7 illustrates the relationship between sound frequency and the improvement in sound transmission loss for three different dash mat configurations as a result of plaque testing: curve 70 represents the transmission loss through a firewall with a constant thickness soft foam layer; curve 72 represents the transmission loss through a constant-thickness firm-flexible foam dash mat with full contact to the firewall; and curve 74 represents the transmission loss using a firm-flexible foam dash mat cored generally as illustrated in FIG. 4. As FIG. 7 illustrates, the cored firm-flexible foams provide generally greater sound reduction over a substantial range of higher frequencies than either the soft foam or the full contact firm-flexible foam. As also illustrated by curve 72, a full contact firm-flexible foam provides improved low frequency transmission loss than either cored firm-flexible foam (curve 74) or soft foam (curve 70).

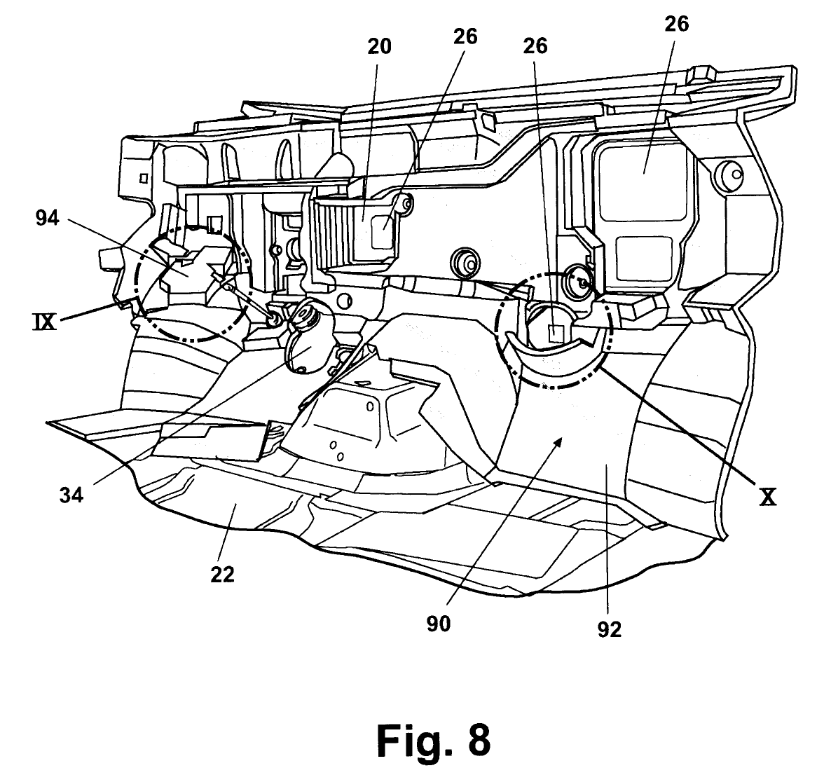

FIG. 8 illustrates an alternate embodiment of the invention comprising a lightweight, firm-flexible foam dash mat 90 in which the core structure is limited to areas such as 94, so that the dash mat 90 is in nearly full contact with the firewall 20. In this configuration, an increased foam thickness around pass-through components will improve high frequency transmission loss. As with the previously-described dash mat 10, the dash mat 90 is adapted to overlay the firewall 20 in general conformance with the shape of the firewall 20.

The dash mat 90 has a varying thickness based upon variations in the sound characteristics along the firewall 20. In regions where the sound is a higher frequency, a thinner section is utilized. Conversely, in regions where the sound intensity is high, a thicker section is utilized. Adjacent the firewall cutouts 26, the dash mat 90 can be contoured to the configuration of the device served by the cutout, such as an air conditioner/heater module, to provide an appropriate thickness and structure to enhance the attenuation of the sound associated with the cutout.

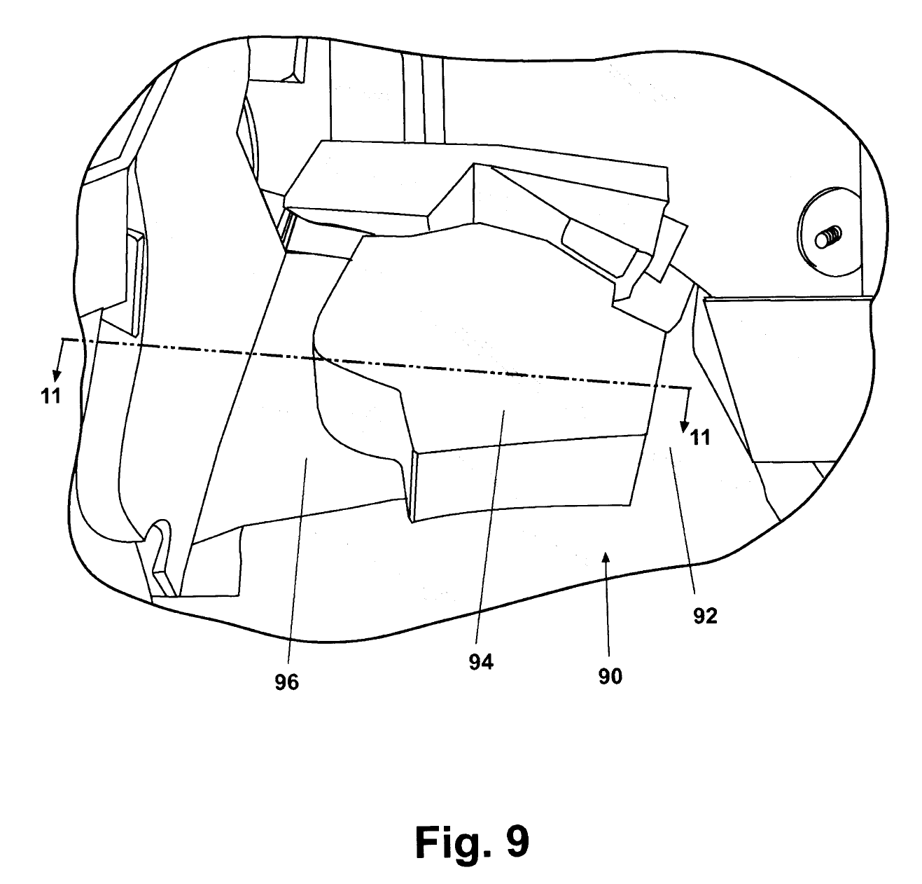

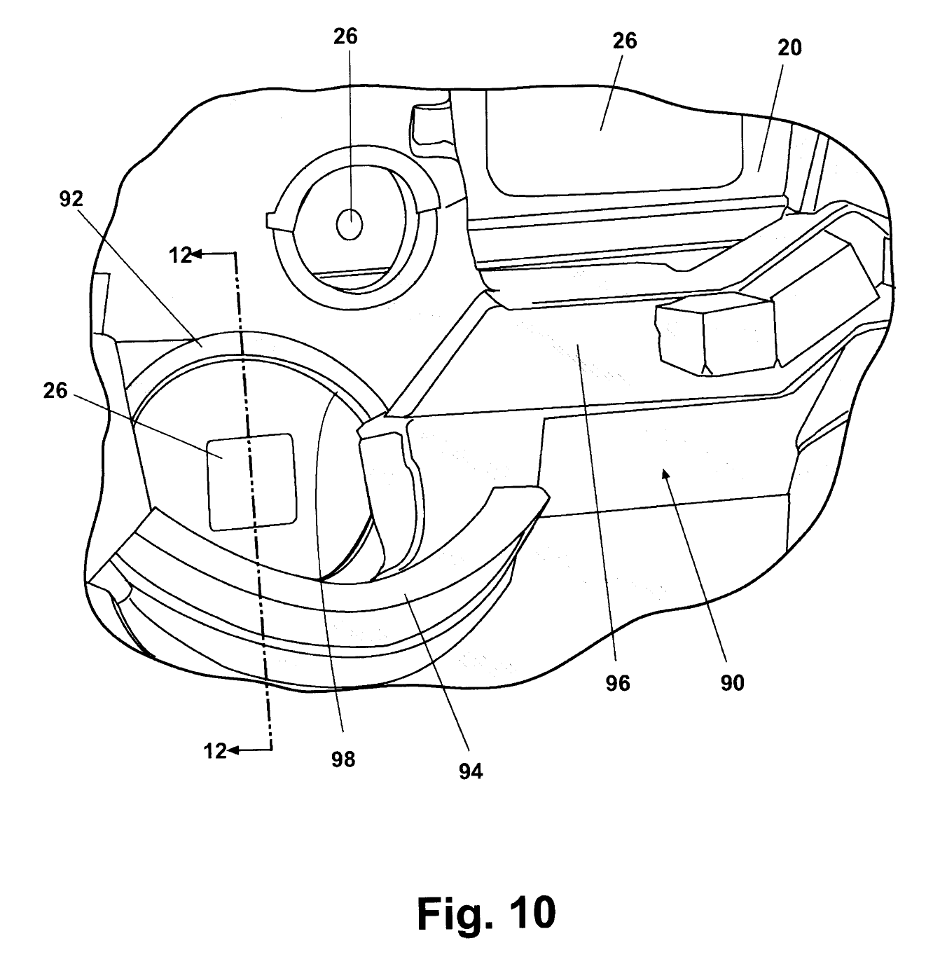

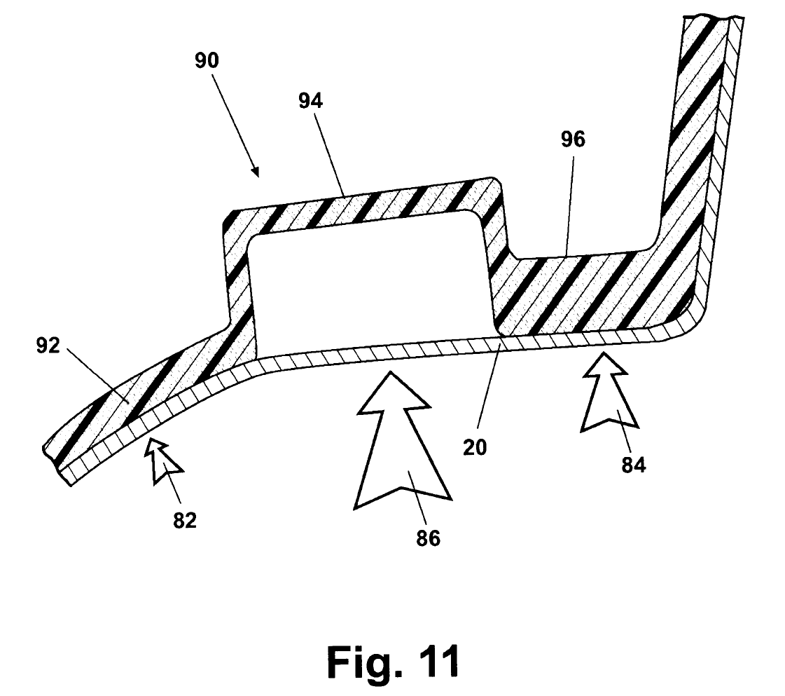

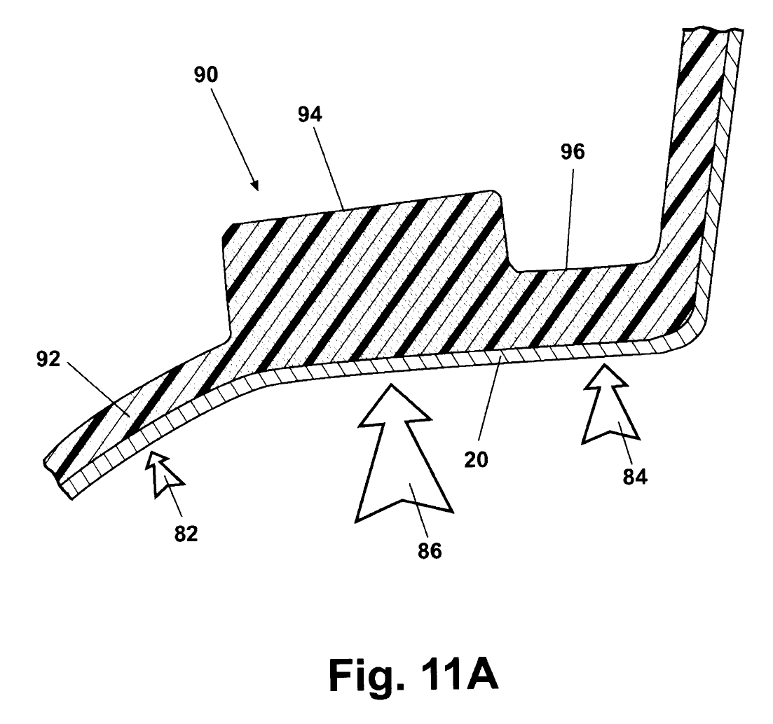

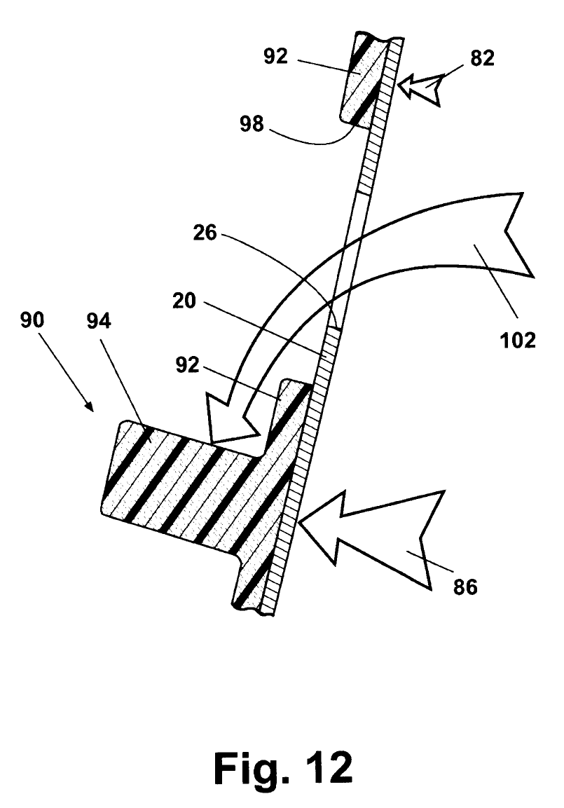

FIGS. 9 and 11 illustrate a section of the dash mat 90 having a varying thickness to accommodate variations in sound intensity along the firewall 20. A thin section 92 is utilized where the sound intensity is comprised of low frequency sound, as illustrated by the smallest arrow 82 in FIG. 11. The thin section 92 transitions to an intermediate section 96 where the sound has a somewhat greater intensity, as illustrated by the medium-sized arrow 84, which in turn transitions to a thin section 94 with a large recess where the sound has the greatest high frequency intensity, as illustrated by the largest arrow 86. As illustrated in FIGS. 10 and 12, the dash mat 90 comprises a cutout section 98 adjacent a firewall opening 26 having a somewhat greater thickness and a selected shape, in this example arcuate, adapted to enhance the attenuation of sound associated with the opening 26, as illustrated by the arrow 102 extending through the opening 26 in FIG. 12.

As illustrated in FIG. 11A, the section 94 can alternatively comprise a thick section of foam without a core to accommodate sound having a particular frequency and intensity at that location along the substrate 28.

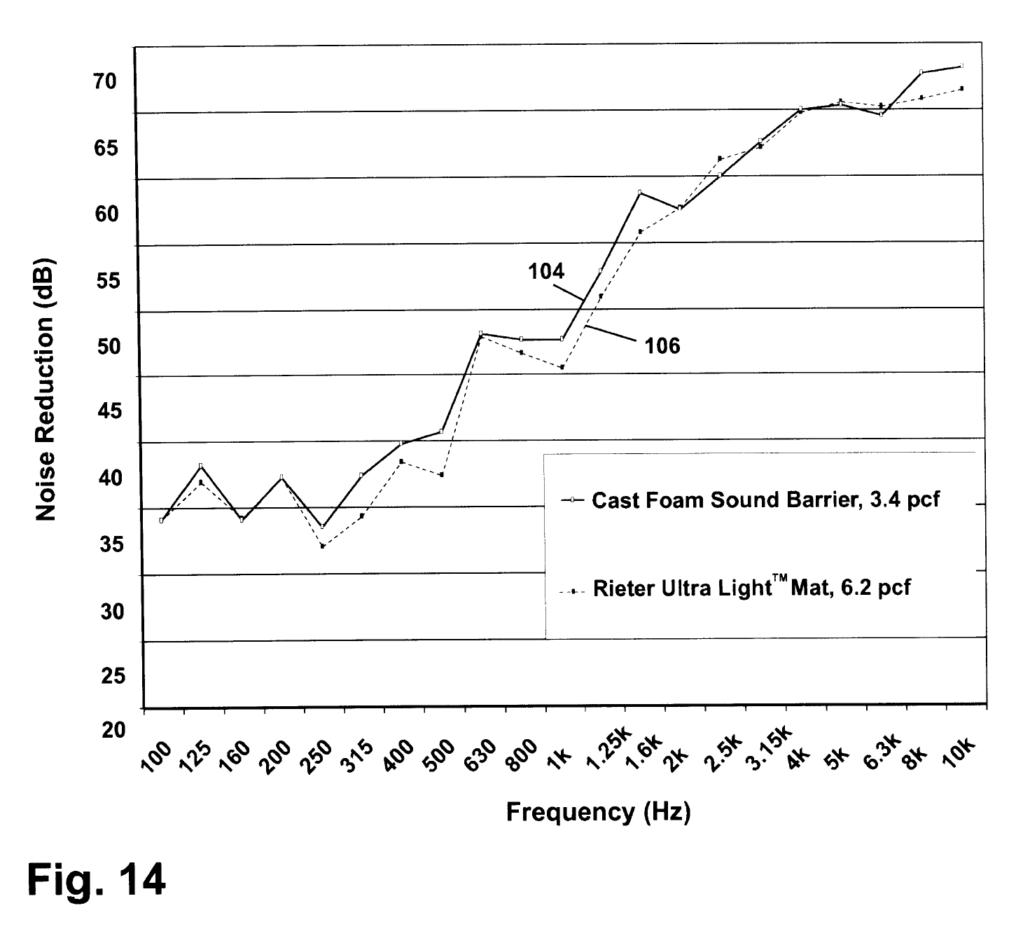

FIG. 14 illustrates the results of testing the acoustic performance of the lightweight foam and a conventional two-layer mat over a frequency spectrum. The testing was performed in a laboratory setting utilizing buck test samples comprising dash mats installed over a conventional vehicle firewall. The 110I lightweight foam summarized in Table 1 was selected for the buck testing. The results for the 110I lightweight foam are exemplified by curve 104 in FIG. 14.

The buck test samples consisted of generally full-scale mockups of a dash mat installed against a conventional vehicle firewall. The firewall was removed at the pillars and across the floor from a stock automobile with all of the parts, such as the heating/air conditioning console, instrument panel frame, steering wheel, etc., included. A reverberant source chamber was positioned on the engine side of the buck test sample and an anechoic chamber was positioned on the passenger side of the buck test sample.

Two speakers were positioned on the firewall side of the test sample, which generated pink noise, a broad frequency spectrum noise having equal intensity levels at every frequency. A microphone was positioned on each side of the test sample, the microphone on the firewall side serving as a source microphone and the microphone on the foam side serving as an anechoic or receiver microphone. With the speakers generating pink noise, the response, i.e. the sound level, of each microphone was measured. The difference in sound level represented the reduction in sound due to the dash mat. This difference was compared for both the lightweight foam dash mat described herein, having an index value of 110I, and for a Rieter Ultra Light™ dash mat.

The conventional two-layer mat is exemplified by curve 106, and comprised a mat comprising a fibrous absorption layer bonded to a conventional mass layer, marketed under the trade name Rieter Ultra Light™. The Rieter Ultra Light™ dash mat comprises a cotton shoddy formed of recycled fiber impregnated with resin at and somewhat below the surface facing the passenger compartment of the vehicle, with a scrim forming a finished surface on the shoddy. The material comprises regular cotton shoddy at the substrate and progressively increases in density toward the scrim as a result of the resin impregnation. As FIG. 14 illustrates, the noise-reducing properties of the lightweight foam barrier are equivalent to, and at certain frequencies better than, the Rieter Ultra Light™ mat, but at a significant reduction in weight.

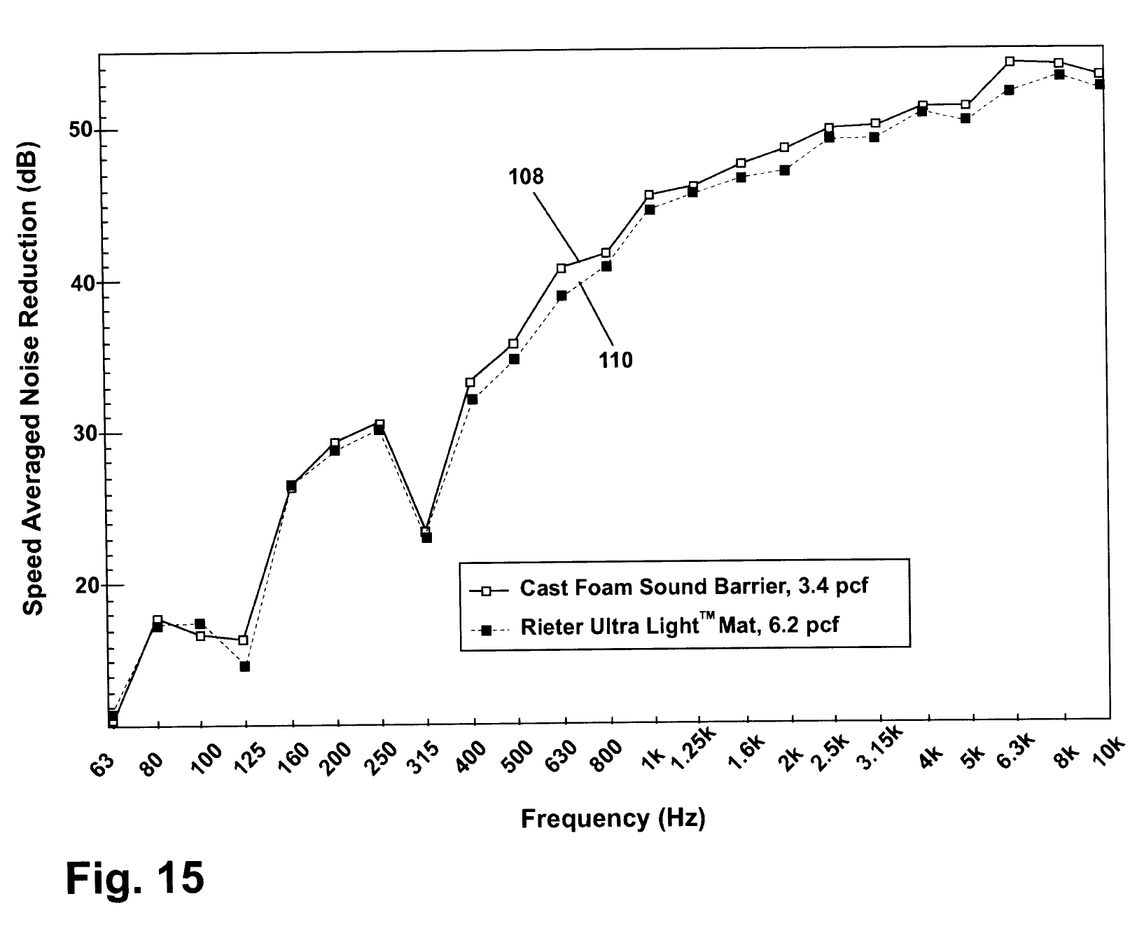

FIG. 15 illustrates the results of testing the acoustic performance of the lightweight foam and the Rieter Ultra Light™ dash mat in a vehicle operated to replicate actual operation. The test consisted of operating a vehicle at wide-open throttle acceleration in first gear on a roller dynamometer within a hemi-anechoic room. The lightweight foam barrier is exemplified in curve 108. The Rieter Ultra Light™ dash mat is exemplified in curve 110. As FIG. 14 illustrates, the noise reducing properties of the lightweight foam barrier are equivalent to or better than the Rieter Ultra Light™ mat, but at a significant reduction in weight.

Further enhancement of the sound-reducing properties of the dash mat 90 can be achieved by the incorporation of cores, such as the core structure illustrated in FIGS. 1-6 or a configuration of appropriately-shaped cores, at selected locations in the foam, or by the use of a thin, lightweight mass layer applied at selected locations to the foam.

As with the previously-described dash mat 10, the dash mat 90 is made of a firm-flexible foam that is sufficiently firm to maintain the integrity of the molded shape for handling, shipping, and installation without undue bending or deformation.

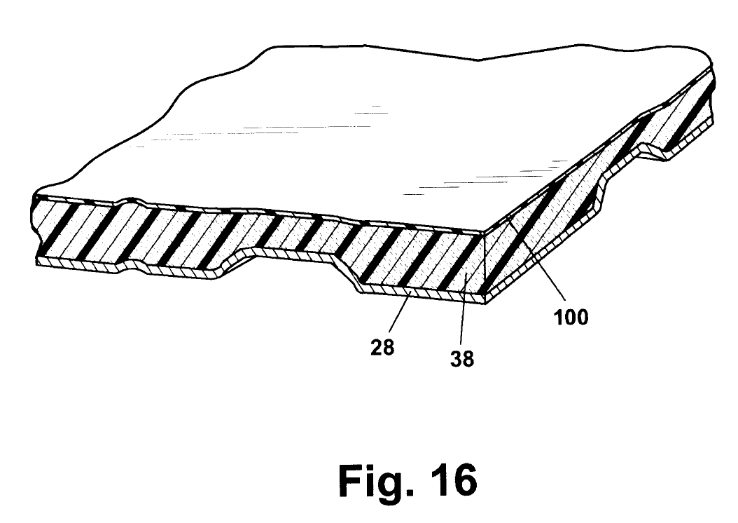

As illustrated in FIG. 16, the foam 38 in contact with the substrate 28 can be overlaid with a thin, lightweight mass layer 100. The mass layer 100 can comprise a generally impervious barrier comprising a polymeric material such as a polyethylene film. In a preferred embodiment, the film has a thickness of no more than 1 millimeter. The mass layer 100 adds little or no structural strength to the lightweight foam dash mat 10, but enhances the sound-blocking properties of the foam 38 at selected areas.

A test of the acoustical performance of the lightweight foam with a thin lightweight mass layer was performed on a cored plaque sample in which the foam layer was identical to sample 5 of Table 2. The mass layer comprised a polypropylene film having a thickness of 0.008″. The transmission loss results are illustrated in Table 3, and are comparable to the results for sample 5. The high frequency transmission loss was improved, as would be expected for foam having a mass layer.

TABLE 3
Stiffness, Density, Dimensions, and Transmission Loss
Cored Plaque Sample with Lightweight Mass Layer

| | | Modified | | | | | | Average | |
|---|---|---|---|---|---|---|---|---|---|
| | | Force | | | | | | Transmission | Sample |
| Sample | | Deflection, | Density, | Density, | “A”, | “B”, | “C”, | Loss, | Thickness, |
| No. | Index | lb. | kg/m3 | pcf | in. | in. | in. | dB | in. |
| 5A | 110I | 32 | 55.4 | 3.46 | .75 | 1.5 | 1.5 | 43.2 | 1.008 |

The dash mat can be formed by an open or closed pour process, with the preferred process being an open pour utilizing a two-piece mold. The components are mixed in a suitable mixing/delivery machine, and delivered into the lower mold where expansion of the foam takes place. The upper mold is then positioned on the lower mold to form the top surface of the dash mat during curing. The molds are maintained at a temperature of 120-150° F. during the delivery and curing process.

The molded lightweight foam acoustical barrier described herein provides the desirable sound-attenuation properties typically achieved with dual-layer barriers, but with a significant improvement in weight reduction, thereby contributing to fuel economy. The structural integrity of the firm-flexible foam enables the acoustical barrier to be readily fabricated, shipped, and attached to a substrate without the handling (e.g. deformation) or attachment problems associated with softer foams. Prior art two-layer dash mats require a first molding process (injection or thermoforming) for the mass or barrier layer, and a second molding process for the molded sound absorbing foam layer, followed by attaching the molded foam layer to the barrier or mass layer. This multi-step fabrication process can add significant cost to the dash mat, which is eliminated with the single-layer foam barrier.

The sound-attenuation properties of the barrier can be precisely tailored through the use of cores, variations in thickness, or a combination of both, to accommodate variations in the sound intensity along the substrate, thereby maximizing sound attenuation to the vehicle passenger compartment while minimizing the weight of the acoustical barrier.

While the invention has been specifically described in connection with certain specific embodiments thereof, it is to be understood that this is by way of illustration and not of limitation. Reasonable variation and modification are possible within the scope of the forgoing description and drawings without departing from the spirit of the invention, which is described in the appended claims.

1. An acoustical barrier comprising a sheet of lightweight firm-flexible foam formed into a shape that is adapted to be mounted to a sound-transmitting substrate and having acoustic properties that meet both requisite sound absorption and sound transmission attenuation standards:

2. An acoustical barrier according to claim 1 wherein the sheet is molded into a complex shape.

3. An acoustical barrier according to claim 1 wherein the formed foam sheet has sufficient stiffness that it retains its shape during handling, shipment, and installation.

4. An acoustical barrier according to claim 3 wherein the acoustical barrier has an obverse surface and a reverse side, and wherein patterned recesses are formed in at least a portion of the reverse side, and wherein the patterned recesses are adapted to attenuate the transmission of sound from a sound-transmitting substrate against which the reverse side of the acoustical barrier is adapted to be placed.

5. An acoustical barrier according to claim 4 wherein the spacing and pattern of the recesses define a regular array.

6. An acoustical barrier according to claim 4 wherein the spacing and pattern of the recesses define an irregular array.

7. An acoustical barrier according to claims 4 wherein the spacing and pattern of the recesses define a regular array of spaced support columns that are adapted to contact the sound-transmitting substrate when the acoustical barrier is installed on the sound-transmitting substrate.

8. An acoustical barrier according to claim 4 wherein the thickness of the sheet varies to exhibit different acoustical properties at different portions of the sheet.

9. An acoustical barrier according to claim 3 wherein the thickness of the sheet varies to exhibit different acoustical properties at different portions of the sheet.

10. An acoustical barrier according to claim 1 wherein the foam has a density in the range of about 2 to 9 lb/cu ft.

11. An acoustical barrier according to claim 10 wherein the foam has a density of about 3.5 lb/cu ft.

12. An acoustical barrier according to claim 11 wherein the foam has a stiffness of between 30 and 300 pounds-force at a 25% indentation force deflection (IFD) using a 20″×20″×2″ test sample pursuant to ASTM D3574-01 specifications.

13. An acoustical barrier according to claim 12 wherein the foam has a stiffness of at least 30 pounds-force at a 25% indentation force deflection (IFD) using a 20″×20″×2″ test sample pursuant to ASTM D3574-01 specifications.

14. An acoustical barrier according to claim 10 wherein the foam has a stiffness of between 30 and 300 pounds-force at a 25% indentation force deflection (IFD) using a 20″×20″×2″ test sample pursuant to ASTM D3574-01 specifications.

15. An acoustical barrier according to claim 1 wherein the foam has a stiffness of between 30 and 300 pounds-force at a 25% indentation force deflection (IFD) using a 20″×20″×2″ test sample pursuant to ASTM D3574-01 specifications.

16. An acoustical barrier according to claim 1 and further comprising a thin impervious barrier layer overlying the foam layer.

17. An acoustical barrier according to claim 1 wherein the foam sheet when mounted to a steel substrate has sound transmission loss properties at least as great as that shown on curve 108 on the graph of FIG. 15.

18. An acoustical barrier according to claim 1 wherein the foam sheet when mounted on a steel substrate has sound transmission loss properties at least as great as that shown on the curve 72 on the graph of FIG. 7.

19. An acoustical barrier according to claim 1 wherein the foam has a porosity in the range of about 20 to 120 cells per inch.

20. A dash mat adapted to be installed against a firewall in a motor vehicle and within the passenger compartment of the vehicle comprising a single layer of molded lightweight firm-flexible foam that has a shape that generally conforms to the firewall of the vehicle and has acoustic transmission loss properties that are at least as great as those represented by curve 74 illustrated in FIG. 7 hereof.

21. A dash mat according to claim 20 wherein the foam layer has selected areas that are configured to adjust the acoustical properties of the foam layer to match predetermined sound transmission requirements at selected corresponding areas of the firewall.

22. A dash mat according to claim 21 wherein at least one of the selected areas has patterned recesses along a reverse side of the foam layer that attenuate transmission sounds through the foam layer.

23. A dash mat according to claim 22 wherein the spacing and pattern of the recesses define a regular array.

24. A dash mat according to claim 22 wherein the spacing and pattern of the recesses define an irregular array.

25. A dash mat according to claim 22 wherein at least one of the selected areas has an enlarged wall thickness to increase the sound absorption through the foam layer.

26. A dash mat according to claim 25 wherein the enlarged wall thickness at least partially surrounds an opening in the foam layer.

27. A dash mat according to claim 21 wherein the foam layer has sufficient stiffness to retain its shape during packaging, shipment, and installation.

28. A dash mat according to claim 20 wherein the foam layer has sufficient stiffness to retain its shape during packaging, shipment, and installation.

29. A dash mat according to claim 20 wherein the thickness of the foam layer varies to exhibit different acoustical properties at different portions of the dash mat.

30. A dash mat according to claim 20 wherein the foam layer has a density in the range of about 2 to 9 lb/cu ft.

31. A dash mat according to claim 30 wherein the foam layer has a density of about 3.5 lb/cu ft.

32. A dash mat according to claim 31 wherein the foam layer has a stiffness of between 30 and 300 pounds-force at a 25% indentation force deflection (IFD) using a 20″×20″×2″ test sample pursuant to ASTM D3574-01 specifications.

33. A dash mat according to claim 30 wherein the foam layer has a stiffness of between 30 and 300 pounds-force at a 25% indentation force deflection (IFD) using a 20″×20″×2″ test sample pursuant to ASTM D3574-01 specifications.

34. A dash mat according to claim 20 wherein the foam layer has a stiffness of at least 30 pounds-force at a 25% indentation force deflection (IFD) using a 20″×20″×2″ test sample pursuant to ASTM D3574-01 specifications.

35. A dash mat according to claim 20 wherein the foam layer has a stiffness of between 30 and 300 pounds-force at a 25% indentation force deflection (IFD) using a 20″×20″×2″ test sample pursuant to ASTM D3574-01 specifications.

36. A dash mat according to claim 20 and further comprising a thin impervious barrier layer overlying the foam layer.

37. A dash mat according to claim 20 wherein the foam has porosity in the range of 20 to 120 pores per inch.

38. A dash mat according to claim 20 wherein the dash mat has acoustic transmission loss properties that are at least as great as those represented by curve 108 on the graph illustrated in FIG. 15 hereof.

39. A vehicle having a firewall separating an engine compartment from a passenger compartment and having a dash mat according to claim 20 positioned within the passenger compartment against the firewall.

40. A method of attenuating sound through a firewall between a motor compartment and a cabin of a vehicle comprising the steps of;
mapping the sound transmission through the firewall between the engine compartment and the cabin as a function of a set of coordinates of a cabin surface of the firewall that faces the cabin;
selecting a firm-flexible foam that has both sound transmission and sound absorbing properties and that has structural integrity for handling, shipping and installation;
designing a layer of the selected firm-flexible foam in a shape that generally conforms to the cabin surface of the firewall and that has selected areas that are designed with configurations that have different acoustical properties that correspond to the mapped sound transmission properties as a function of the set of coordinates; and
molding the designed layer into a shape to generally conform to the cabin surface.

41. A method according to claim 40 and further comprising the step of installing the molded layer onto the firewall cabin surface of the vehicle.

42. A method according to claim 41 and further comprising the step of placing at least portions of the foam layer in full contact with the firewall cabin surface.

43. A method according to claim 40 wherein the designing step includes the step of designing at least one selected area with patterned recesses along a reverse side of the foam layer that attenuate transmission sounds through the foam layer.

44. A method according to claim 43 wherein the spacing and pattern of the recesses define a regular array.

45. A method according to claim 43 wherein the spacing and pattern of the recesses define an irregular array.

46. A method according to claim 43 wherein the designing step includes the step of designing at least one selected area with an enlarged wall thickness to increase the sound absorption through the foam layer.

47. A method according to claim 46 wherein the designing step includes the step of designing an opening in the foam layer and designing the enlarged wall thickness to at least partially surround the opening in the foam layer.

48. A method according to claim 40 wherein the designing step further comprising the designing the foam material, the thickness and shape of the foam layer so that the molded foam layer has sufficient stiffness to retain its shape during packaging, shipment, and installation.

49. A method according to claim 40 wherein the designing step includes the step of designing thickness variations in the foam layer to exhibit different acoustical properties at different portions of the dash mat corresponding to selected coordinates of the firewall cabin surface.

50. A method according to claim 40 wherein the foam layer has a density in the range of about 2 to 9 lb/cu ft.

51. A method according to claim 50 wherein the foam layer has a density of about 3.5 lb/cu ft.

52. A method according to claim 51 wherein the foam layer has a stiffness of between 30 and 300 pounds-force at a 25% indentation force deflection (IFD) using a 20″×20″×2″ test sample pursuant to ASTM D3574-01 specifications.

53. A method according to claim 50 wherein the foam layer has a stiffness of between 30 and 300 pounds-force at a 25% indentation force deflection (IFD) using a 20″×20″×2″ test sample pursuant to ASTM D3574-01 specifications.

54. A method according to claim 40 wherein the foam layer has a stiffness of at least 30 pounds-force at a 25% indentation force deflection (IFD) using a 20″×20″×2″ test sample pursuant to ASTM D3574-01 specifications.

55. A method according to claim 40 wherein the foam layer has a stiffness of between 30 and 300 pounds-force at a 25% indentation force deflection (IFD) using a 20″×20″×2″ test sample pursuant to ASTM D3574-01 specifications.

56. A method according to claim 40 wherein the foam has porosity in the range of about 20 to 120 cells per inch.

57. A method according to claim 40 wherein the designing step includes designing the sound attenuation characteristics of the dash mat to have the acoustic transmission loss properties that are at least as great as curve 72 illustrated in FIG. 7 hereof.

58. A method according to claim 40 wherein the designing step includes designing the sound attenuation characteristics of the dash mat to have the acoustic transmission loss properties that are at least as great as those represented by curve 74 illustrated in FIG. 7 hereof.
